(19) United States
(12) Patent Application Publication
(10) Pub. No.: US 2026/0258758 A1
(43) Pub. Date: Sep. 3, 2026

(54) IMPROVEMENTS RELATING TO INTERNAL COMBUSTION ENGINES

(71) Applicant: Commonwealth Scientific and Industrial Research Organisation, Acton, Australian Capital Territory (AU)

(72) Inventors: Louis James WIBBERLEY, Mayfield, New South Wales (AU); Durgada SANKESH, Acton, Australian Capital Territory (AU)

(21) Appl. No.: 19/489,210

(22) PCT Filed: May 31, 2024
(86) PCT No.: PCT/AU2024/050579

§ 371 Date: Dec. 1, 2025

(30) Foreign Application Priority Data
Jun. 2, 2023 (AU) 2023901756
Mar. 28, 2024 (AU) 2024900851

(51) Int. Cl. F02D 19/06; F02B 19/10; F02B 19/12; F02B 43/10; F02D 19/08; F02M 21/02

(52) U.S. Cl. CPC F02D 19/0671; F02B 19/1085; F02B 19/12; F02B 43/10; F02D 19/061; F02D 19/0628; F02D 19/0634; F02D 19/0644; F02D 19/0686; F02D 19/081; F02M 21/0206; F02M 21/0227

(57) ABSTRACT

The disclose relates to an ammonia-fuelled internal combustion engine system. The engine system comprises a cracking device connectable to an ammonia fuel supply and configured, during operation of the engine, to produce a cracked fuel comprising a mixture of nitrogen and hydrogen by cracking of an ammonia fuel provided by the ammonia fuel supply. The engine system further comprises a main combustion chamber, an intake and an exhaust each in fluid communication with the main combustion chamber. A precombustion chamber is in fluid communication with the main combustion chamber via at least one orifice, the precombustion chamber further comprises a cracked fuel inlet to permit introduction of the cracked fuel, supplied from the cracking device, into the precombustion chamber. An ignition device is operatively positioned with the precombustion chamber and configured to ignite the cracked fuel in the precombustion chamber. The precombustion chamber and/or the orifice are configured to produce a stream of combusting fluid from the precombustion chamber to the main combustion chamber via the orifice, when cracked fuel is ignited in the precombustion chamber, so as to permit ignition of fuel present in the main combustion chamber. The engine system further comprises a sensor arrangement configured to measure properties of the cracked fuel and an electronic control device in communication with the sensor arrangement and with the ignition device. The electronic control device is configured to evaluate a characteristic of the hydrogen present in the cracked fuel using measurements received from the sensor arrangement and to control introduction of cracked fuel into the precombustion chamber according to those evaluated hydrogen characteristics.

### PRIORITY CROSS-REFERENCE

The present application claims priority from Australian Provisional Patent Application No. 2023901756 filed 2 Jun. 2023 and Australian Provisional Patent Application No. 2024900851 filed 28 Mar. 2024, the contents of which are hereby incorporated into the present specification by this reference.

### TECHNICAL FIELD

The present disclosure relates generally to internal combustion engines, related apparatus, methods and control systems. In particular, the disclosure relates to internal combustion engines comprising a main combustion chamber as well as a pre-combustion chamber (or ‘prechamber’) configured to facilitate combustion of fuel in the main combustion chamber.

### BACKGROUND OF DISCLOSURE

The following discussion of the background to the disclosure is intended to facilitate an understanding of the disclosure. However, it should be appreciated that the discussion is not an acknowledgement or admission that any of the material referred to was published, known or part of the common general knowledge as at the priority date of the application.

Currently, there is more than ever a need in major countries to reduce the use and dependence on fossil fuels for energy production. CO₂ released into the atmosphere from burning fossil fuels has been widely reported to increase warming of the planet which is expected to cause rise in average temperatures and in turn affect our climate adversely. The transportation sector alone contributes to a significant portion of CO₂ release from burning fossil fuels in internal combustion engines.

Ammonia can be an excellent zero-carbon-emission fuel for internal combustion engines. Ammonia is one of the most widely produced chemicals in the world and is used in various applications such as in fertilisers, refrigeration and chemical processing. As a hydrogen (H₂) carrier fuel, liquid ammonia is approximately 1.5 times more energy dense than liquid hydrogen and can be liquified at relatively low pressures of around 10 bar. This makes storage and transportation of ammonia on a large scale much easier as compared to hydrogen fuel. Consequently, ammonia-fuelled internal combustion engines may be more suited to particular applications or may otherwise be preferred to hydrogen-fuelled internal combustion engines. In addition, ammonia can be fully produced from renewable energy sources.

However, ammonia generally exhibits poor combustion characteristics as a fuel in internal combustion engines, as compared to hydrogen fuel. Ammonia has relatively low flame speeds for use in spark-ignition engines and relatively high auto-ignition temperature for use in diesel engines. This makes robust ignition and combustion of ammonia challenging under wide engine operating conditions.

When used in spark-ignition engines, ammonia (or even mixtures of ammonia and gasoline-like fuels) exhibit longer combustion durations. This can result in reduced engine power, lower thermodynamic efficiency and excessive unburnt ammonia in the exhaust. When used in compression ignition engines, ammonia fuel requires pilot ignition of diesel-like fuel (or other fuels with relatively lower auto-ignition temperatures than ammonia) to ignite and combust the ammonia fuel. Significantly higher compression ratios than currently used in modern diesel engines would be needed to auto-ignite pure ammonia. In addition, liquid ammonia also has much higher latent heat of vaporisation. In both existing spark-ignition engines and existing compression ignition configurations, even where ammonia fuel is mixed with another form of fuel to facilitate combustibility, still a significant amount of unburnt ammonia in the exhaust can be expected.

In response to these drawbacks with ammonia-fuelled internal combustion engines, pre-combustion chambers (also known as prechambers) have been developed to improve combustion performance over conventional spark-ignition combustion and especially in large bore gas engines in which drawbacks associated with low flame speed are exacerbated by the large cylinder volume.

Prechambers are typically provided as a smaller chamber in fluid communication with the main chamber whereby the prechamber is configured for initial combustion which then facilitates combustion of fuel in the main chamber. The pre-combustion occurring in the prechamber operates as a much stronger ignition source for the main chamber than is possible via, for example, a spark-ignition system in a conventional gasoline-type engine.

A promising solution to combust ammonia fuel more efficiently in internal combustion engines is to use hydrogen as an ignition enhancer. Hydrogen has excellent combustion properties including very high flame speeds and much wider flammability limits as compared to conventional hydrocarbon fuels such as gasoline. Recent studies have shown that ammonia-hydrogen mixtures can improve combustion speed as compared to pure ammonia.

Ongoing development in this field is desirable. In particular, improvements in combustion efficiency, cost effectiveness and/or ease of manufacture/operation.

### SUMMARY OF DISCLOSURE

According to an aspect of the present disclosure, there is provided an ammonia-fuelled internal combustion engine system, related apparatus, methods and controls systems. Some of the examples described provide improvements in one or more of combustion efficiency, cost effectiveness and/or ease of manufacture/operation.

In one example, there is provided a system comprising: a cracking device connectable to an ammonia fuel supply. The cracking device may be configured, during operation of the engine, to produce a cracked fuel comprising a mixture of nitrogen and hydrogen by cracking of an ammonia fuel provided by the ammonia fuel supply. The system may comprise a main combustion chamber, an intake and an exhaust each in fluid communication with the main combustion chamber.

The system may comprise a precombustion chamber in fluid communication with the main combustion chamber via at least one orifice. The precombustion chamber may further comprise a cracked fuel inlet to permit introduction of the cracked fuel, supplied from the cracking device, into the precombustion chamber;

The system may comprise an ignition device operatively positioned with the precombustion chamber and configured to ignite the cracked fuel in the precombustion chamber. The precombustion chamber and/or the orifice may be configured to produce a stream of combusting fluid from the precombustion chamber to the main combustion chamber via the orifice, when cracked fuel is ignited in the precombustion chamber, e.g., so as to permit ignition of fuel present in the main combustion chamber.

The system may comprise a sensor arrangement configured to measure properties of the cracked fuel. The sensor arrangement may be configured to measure properties of the cracked fuel, directly and/or indirectly.

The system may comprise an electronic control device in communication with the sensor arrangement and with the ignition device. The electronic control device may be configured to evaluate a characteristic of the hydrogen present in the cracked fuel using measurements received from the sensor arrangement. The control device may be configured to control introduction of cracked fuel into the precombustion chamber according to those evaluated hydrogen characteristics.

An internal combustion engine system having the above-noted configuration may be advantageously configured to control fuel introduction based on hydrogen characteristics of the cracked fuel. In this way, the electronic control device may be provided with feedback regarding the characteristics of the cracked fuel and, in particular, the characteristics of the hydrogen present in the cracked fuel.

The internal combustion engine system may also be provided with a cracking device to advantageously provide ‘in situ’ hydrogen production from an ammonia-based fuel. The cracking device may also be known as a decomposition device which cracks ammonia into hydrogen and nitrogen. The cracking device may be configured to supply some or all of the hydrogen present in the precombustion fuel supply. Depending on the efficiency of the cracking device, it is envisaged that the precombustion fuel mixture could also comprise uncracked ammonia. Therefore, the output mixture of the cracking device may be a mixture of ammonia, hydrogen and nitrogen (e.g., and may be considered to have been partially cracked).

The cracking device may be a catalytic cracking device. For example, the cracking device could comprise an appropriate catalyst which induces decomposition upon contact with the ammonia supply. Alternatively, the cracking device could be a non-catalyst cracking device and, for example, could comprise a thermal ammonia decomposition cracking device.

The cracked fuel may be used exclusively as a fuel source. For example, both the precombustion chamber and the main combustion chamber could be fuelled with cracked fuel. Alternatively, the hydrogen-containing cracked fuel could be used as a high-reactivity precombustion fuel which is used to facilitate combustion of a lower-reactivity fuel in the main combustion chamber. For example, the cracked fuel could be used to facilitate combustion of ammonia fuel present in the main combustion chamber. It should therefore be appreciated that the term ‘ammonia-fuelled engine’ encompasses an engine which is fuelled directly by ammonia introduced into the main combustion chamber and encompasses also an engine which is fuelled by an ammonia fuel supply which is cracked (e.g., fully or partially cracked) into constituent compounds prior to introduction into the engine.

It will be appreciated that the engine may comprise typical components and features present in known internal combustion engines. The engine of this disclosure may comprise a two-stroke engine. The engine of this disclosure may comprise a four-stroke engine. The engine system may be a reciprocating engine and may comprise a piston within a cylinder. The intake and exhaust may typically be in fluid communication with the main combustion chamber. The engine system could comprise a rotary engine such as a Wankel-type rotary engine and in which case may comprise a housing and a rotor.

The intake may comprise an intake valve. The intake may be an intake port or comprise a plurality of ports. The one or more intake ports could be provided with one or more intake valves. The exhaust may comprise an exhaust valve or comprise a plurality of exhaust valves. The exhaust may be an exhaust port or comprise a plurality of exhaust ports. The cylinder intake could be an air-only intake. This may occur in configurations where fuel is not supplied to the inlet manifold and, for example, where fuel is supplied to the main combustion chamber through the precombustion chamber or where fuel is supplied via ‘direct injection’ to the main combustion chamber. In alternative configurations, the intake could provide an air-fuel mixture into the main combustion chamber.

The evaluated characteristics of the hydrogen present in the cracked fuel could comprise hydrogen concentration and, for example, the percentage of hydrogen in the total hydrogen and ammonia present in the cracked gas. The evaluated characteristics could comprise pressure and temperature of the cracked fuel. It will be appreciated that a measured pressure or temperature of the cracked fuel is also a measurement of hydrogen pressure and temperature in the cracked fuel.

The sensor arrangement may be configured to measure properties of the cracked fuel. This may be performed via a direct measurement of the cracked fuel. For example, the sensor arrangement may be in contact with, or in proximity to, the cracked fuel. The sensor arrangement could be located in a flow path of the cracked fuel. In a particular example, the sensor arrangement could be configured to perform a direct measurement of pressure and temperature of the cracked fuel. It will be appreciated that these measurements correspond to a measurement of hydrogen pressure or temperature in the cracked fuel.

The sensor arrangement could be configured additionally or alternatively to indirectly measure properties of the cracked fuel. For example, the sensor arrangement could be configured to measure properties obtained indirectly with respect to the cracked fuel (e.g., in addition to or instead of measuring the fuel directly). For example, the sensor arrangement in some cases may not measure the cracked fuel directly, but may be configured to measure a proxy or secondary indicator of cracked fuel properties. For example, the sensor arrangement could be configured to measure properties of the cracking device from which properties of the cracked fuel could be measured (e.g., determined or otherwise inferred). The sensor arrangement could be configured to measure properties of the exhaust gas from which properties of the cracked fuel could be measured (e.g., determined or otherwise inferred). It will be appreciated that the sensor arrangement may permit evaluation of cracked fuel properties by the electronic control device and is therefore said to be configured to measure properties of the cracked fuel.

The sensor arrangement could be configured to measure properties of the cracked fuel via direct and indirect measurement of the cracked fuel (e.g., measuring the fuel directly, together with using measurements of the cracking device, to determine properties of the cracked fuel).

The electronic control device according to this disclosure may be configured to perform an evaluation, e.g., direct evaluation, of hydrogen characteristics in the cracked fuel. For example, the sensor arrangement could be associated with the cracked fuel insofar as measurements of fuel characteristics are taken. These measurements may be communicated to the electronic control device which can evaluate the characteristics of the cracked fuel based on the direct fuel measurements taken by the sensor arrangement. In a particular example, the sensor arrangement may comprise pressure and/or temperature sensors. Pressure and/or temperature information may be communicated to the electronic control device which may then be able to evaluate (e.g., directly) pressure and temperature characteristics. Hydrogen concentration, and/or other constituents of the cracked gas, may be determined based on pressure/temperature measurements according to a predefined cracking equilibrium relationship. The sensor arrangement could comprise a single sensor. The sensor arrangement could comprise a plurality of sensors.

In an example of an indirect evaluation, the electronic control device may be configured to infer characteristics of the cracked fuel based on a secondary indicator of fuel properties taken by the sensor arrangement. For example, the sensor arrangement could provide the electronic control device with measurements of the engine exhaust and from which the electronic control device could evaluate properties, such as hydrogen properties, in the cracked fuel. The sensor arrangement could provide the electronic control device with information relating to the cracking device. For example, the sensor arrangement may comprise a temperature sensor configured to measure cracking device temperature. The electronic control unit device may be configured to evaluate a characteristic of certain constituents, such as hydrogen, present in the cracked fuel using the cracking device temperature measurement received from the cracking device temperature sensor. The electronic control device may receive cracking device temperature information and compare this to predetermined cracked fuel characteristics as a function of temperature. Such predetermined cracked fuel characteristics may be stored by, downloadable to, or are otherwise available to the electronic control device.

In typical applications, hydrogen concentration may predominately be a function of cracking temperature for a given cracker device design. In an embodiment of this disclosure, the electronic control device may be provided with (e.g., store) a predetermined map of temperature vs hydrogen concentration (i.e. hydrogen % in cracked gas output). Such map may be used by the electronic control device to evaluate hydrogen concentration as a function of real-time temperature measurement of the cracker device.

In one embodiment, the electronic control device may evaluate hydrogen concentration in the cracked fuel based on real-time temperature measurements which are compared against predetermined values of cracked fuel hydrogen concentration for the particular cracking device, e.g., as a function of temperature. In a particular embodiment, an indication of the hydrogen concentration in the cracked fuel may be measured indirectly from other constituents, e.g., ammonia and/or nitrogen measurements, and then calculated. This may be achieved, (with acceptable accuracy) from the equilibrium decomposition reaction: 2NH3→N2+3H2.

A range of measurement devices are available for the relevant gases, for example ceramic ammonia sensors presently used for measuring unreacted ammonia in exhaust gases of engines equipped with selective catalytic reduction of nitrogen oxides. An example instrument is the ECM NOx/NH3 5240 analyser. In a particular embodiment, the engine system of the present disclosure may be provided with several detectors or sensors with overlapping measurement ranges. This may provide a requisite level or fine control which is particularly desirable at higher engine speeds.

The sensor arrangement may be configured to provide a real-time indication of cracked fuel properties, which may allow the electronic control device to optimise the introduction of fuel into the precombustion chamber. In a particular embodiment, the cracked fuel supply upstream of the cracked fuel inlet may be provided with one or more of a hydrogen concentration sensor, a pressure sensor and a temperature sensor.

In a particular embodiment of this disclosure, the sensor arrangement and the electronic control device may be configured to evaluate hydrogen concentration in the cracked fuel. It will be appreciated that performance of a cracking device may not typically produce a consistent mixture of cracked fuel during operation. The hydrogen concentration in the precombustion fuel supply may be prone to variance. The composition of the cracked fuel may vary particularly as a function of temperature of the cracking device. The amount of hydrogen present in the cracked fuel may therefore vary. It will be appreciated therefore that an ongoing evaluation of hydrogen concentration may advantageously enable the electronic control device to control fuel introduction according to the particular amount of hydrogen present in the cracked fuel at a given time.

As mentioned above, an evaluation of hydrogen concentration could occur via a measurement of cracked fuel, e.g., direct measurement. The measurement of hydrogen concentration could be performed using an electrical conductivity sensor. The measurement of hydrogen concentration could be performed using an electrochemical sensor. The evaluation of hydrogen concentration may advantageously inform the electronic control device with respect to ratios of hydrogen-containing precombustion fuel relative to a lower-reactivity main fuel (for example, ammonia). In a particular embodiment, the sensor arrangement is configured to measure the pressure and temperature of the cracked fuel.

In a particular embodiment, the electronic control device is configured to control the duration and timing of the introduction of cracked fuel into the precombustion chamber. The control of the duration and timing may be via communication between the electronic control device and the cracked fuel inlet. The cracked fuel inlet may comprise a cracked fuel injector in communication with the electronic control device. The communication may be electronic communication. The cracked fuel injector may be configured to inject a spray of cracked fuel into the precombustion chamber. The cracked fuel injector may be positioned at the precombustion chamber. The cracked fuel injector may be configured for direct injection of cracked fuel into the precombustion chamber. The cracked fuel injector may be configured to inject cracked fuel indirectly into the precombustion chamber. For example, the cracked fuel injector could be located upstream of a fuel conduit leading to the precombustion chamber.

The evaluated hydrogen characteristics of the cracked fuel may be used by the electronic control device to determine preferred injection parameters such as the injection duration and timing. Injection timing may be set to occur at a particular part of the engine cycle. In piston-containing internal combustion engines, the engine cycle may relate to the position and movement direction of the piston within the cylinder. In rotary engines, the engine cycle may relate to the angular position of the rotor within a housing of the engine. Injection timing may be set to occur at a particular time relative to operation of the ignition device, which may also be controlled by the electronic control device.

In a particular embodiment, the electronic control device is configured to control the amount (for example, the mass) of hydrogen introduced into the precombustion chamber. The electronic control device may be configured to control the amount of hydrogen present in the precombustion chamber by controlling the amount of cracked fuel introduced into the precombustion chamber. In a particular example, the electronic control device may adjust injection timing so as to introduce a particular amount of cracked fuel into the precombustion chamber in order to introduce a particular amount of hydrogen into the precombustion chamber. In this instance, an evaluation of a higher hydrogen concentration in the cracked fuel may correspond to a shortened injection duration and vice versa.

In another example, the electronic control device may be configured to adjust the composition of the cracked fuel introduced into the precombustion chamber. The electronic control device may be configured to control operation of the cracking device to adjust concentration of hydrogen present in the cracked fuel. The electronic control device may be configured to control operation of the cracking device. The electronic control device may be configured to affect performance of the cracking device. For example, the engine may further comprise a controllable heating device configured to heat the cracking device, the heating device being in communication with the electronic control device. The communication may be electronic communication. In this way, the electronic control device may selectively heat the cracking device where it is desired to increase performance of the cracking device e.g., therefore increase the concentration of hydrogen present in the cracked fuel. In a particular embodiment, the electronic control device may control operation of the cracking device according to a target hydrogen concentration in the cracked fuel of 5% to 35% by volume (e.g., during normal operations of the engine system).

The hydrogen concentration refers to the portion of hydrogen in the total combustible fuel, which comprises the sum of hydrogen and ammonia. The hydrogen concentration may therefore be defined according to the following equation:

$${H}_{2} concentration = \frac{{H}_{2}}{{H}_{2} + {NH}_{3}}$$

It should be understood that hydrogen concentration does not refer to the ratio of hydrogen to ammonia, but rather the proportion of the hydrogen and ammonia mixture, that is comprised of hydrogen. This convention is used because hydrogen and ammonia are the combustible fuels present in the cracked fuel and disregards the presence of gases such as nitrogen which are not combustible during engine ignition. The target hydrogen fuel concentration therefore refers to the percentage of combustible fuel which is comprised of hydrogen.

As noted in the foregoing, ammonia decomposition may occur according to the following reaction: 2NH3→N2+3H2. It will be appreciated that the portion of total fuel (H₂+NH₃) which consists of hydrogen will vary according to the efficiency with which ammonia decomposition occurs. As noted, particular embodiments may control performance of the cracking device to achieve a target hydrogen concentration in the combustible fuel of 5-35%. This may be particularly advantageous where a single fuel injector is used to introduce cracked fuel to both the precombustion chamber and the main combustion chamber. In this case, there is no separate ammonia fuel injector operable to dilute the hydrogen concentration down to the target range and therefore the cracking device can be controlled to partially crack to achieve the target range and delivering and igniting the mixture in the cylinder, without the mixture undergoing compositional change. In other words, the operation of cracking device may be provided such that only a certain amount, and not all, of the ammonia is cracked. This may notionally be termed as “efficiency” of the cracking device, albeit that efficiency may be considered to relate to the amount or percentage of cracking, relative to complete cracking being performed (e.g., relative to 100%), rather than any power efficiency, or the like, of the cracking device.

In some embodiments, a hydrogen concentration of 5% may result from approximately 4% cracking of ammonia. In this case, ammonia may be decomposed into a cracked fuel comprising 93% of ammonia, 5% of hydrogen and 2% of nitrogen. In this example, the hydrogen percentage would be 5/(5+93)=^{~}5.1%.

In some embodiments, a hydrogen concentration of 35% may result from approximately 26% cracking of ammonia. In this case, ammonia may be decomposed into a cracked fuel comprising 59% ammonia, 31% hydrogen and 10% nitrogen. In this example, the hydrogen percentage would be 31/(31+59)=^{~}34.4%

The cracking device efficiency may be controllable via adjustment of the cracking device temperature. The cracking device temperature may be controlled in various ways and, for example, by adjusting the amount of exhaust heat that was allowed to exchange with the cracking device. For example, the amount of exhaust heat permitted to exchange with the cracking device could be controlled to maintain cracking efficiency within a target range. Where cracking efficiency was nearing or exceeding the upper limit of a target range, some of the exhaust gas could be selectively bypassed from the cracking device to limit or reduce or otherwise throttle cracking efficiency. Another means of controlling temperature could be a controllable heating device associated with the cracking device. A heating device could operate in cooperation with heating from exhaust gases.

As noted, the target range may be selected to achieve a target hydrogen concentration. The target hydrogen concentration could be in a range of 5%-35% during normal engine system operating conditions but could be higher than this during cold starts or during very cold ambient conditions.

In certain embodiments, a separate ammonia fuel injector may be used to introduce ammonia fuel to the main combustion chamber. In this case, the cracking device could be operated at higher than 26% cracking efficiency to produce a hydrogen concentration of greater than 35%. During fuel injection, the hydrogen fuel concentration in the cracked fuel may be diluted by introduction of ammonia fuel from the ammonia fuel injector and in order to achieve a hydrogen concentration in the cylinder of between 5-35%.

It will be appreciated that in these cases where cracking efficiency is being controlled to deliberately produce a cracked fuel comprising hydrogen and ammonia (for example, a hydrogen concentration within 5-35%), the cracked fuel produced by the cracking device is partially cracked insofar as it comprises uncracked ammonia, hydrogen and nitrogen. In other cases where ammonia fuel is injected separately from the cracked fuel, the cracking efficiency need not be throttled and could be as high as 100%. In this case, the cracked fuel would be completely cracked and would comprise substantially only of hydrogen and nitrogen.

It is noted that control of the cracking device by the electronic control device could occur directly or indirectly. In an example of direct control, the electronic control device could be configured to directly send instructional communication to the controllable heating device. In an example of indirect control, the electronic control device could send instructional communications to an intermediate control device associated with the heating device. It will be appreciated that in either instance, the electronic control device may control operation of the heating device and, in turn, control operation of the cracking device.

In a particular embodiment, the electronic control device can increase cracked fuel introduction duration to introduce the required amount of hydrogen to meet a determined power requirement of the engine. This can be accomplished by pre-determined values as a function of cracking efficiency based on the operating temperature of the cracker device at which ammonia decomposition occurs. The electronic control device can also be programmed to accept the hydrogen percentage in the fuel mixture as an input. In addition, the control device can also be configured to function in a closed-loop system by receiving feedback from sensor arrangement that measures the percentage of hydrogen in the gas mixture output from the fuel source such as an ammonia cracking device and accordingly can actuate the injector/s to inject required amount of hydrogen depending on engine load and speed.

In some embodiments, the fuel present in the main combustion chamber may be cracked fuel produced by the cracking device and introduced into the main combustion chamber via the precombustion chamber, e.g., through an orifice of the precombustion chamber to the main combustion chamber. This configuration may advantageously allow for both chambers to be fuelled from a single cracked fuel inlet. In a particular embodiment, fuelling of the main combustion chamber via the precombustion chamber may be achieved by providing a cracked fuel inlet with sufficiently high flow capacity. This may advantageously avoid the need for a separate fuel inlet to deliver fuel to the main combustion chamber. Fuelling the main combustion chamber via the precombustion chamber may avoid the need for a separate fuel injector located at the engine intake ports (port injection) or on the cylinder head (direct injection). This configuration may be particularly advantageous for two-stroke engines where there is a risk of fuel slip during exhaust scavenging. In particular, fuel slip may be mitigated or avoided by commencing injection after the exhaust valves have been closed. Further, such an arrangement may allow for ease of retrofitting.

As mentioned, the cracked fuel inlet may be a cracked fuel injector in communication with and controllable by the electronic control device. The communication may be electronic communication. In a particular embodiment, the electronic control device is configured to control introduction of cracked fuel into the main combustion chamber by, during operation, controlling the timing and duration of cracked fuel introduction into the precombustion chamber. For example, the electronic control device may set an injection duration to provide a volume of cracked fuel sufficiently high to fuel both the precombustion chamber and the main combustion chamber. The electronic control device may set injection timing to correspond with an intake and/or compression stroke and whereby fuel flow from the precombustion chamber to the main combustion chamber takes place via the orifice(s) as a result of pressure differences arising from the injection event.

The cracked fuel inlet may be configured to deliver cracked fuel to the precombustion chamber at a flow rate which permits fuelling of the main combustion chamber with cracked fuel flowing from the precombustion chamber through the orifice to the main combustion chamber. The fuel inlet may be configured to introduce fuel flow into the precombustion chamber in a flow direction toward the main combustion chamber. The fuel inlet of the precombustion chamber may be orientated towards the orifice through which there is fluid communication between the chambers.

In a particular embodiment of this disclosure, the fuel present in the main combustion chamber comprises ammonia fuel. In an embodiment, the engine system comprises an ammonia fuel inlet configured to introduce ammonia fuel into the main combustion chamber and wherein the ammonia fuel present in the main combustion chamber comprises ammonia fuel provided by the ammonia fuel inlet. The ammonia fuel inlet may be provided with ammonia fuel by the same ammonia fuel supply which supplies ammonia fuel to the cracking device. This configuration advantageously allows for two fuel types (i.e. cracked fuel and uncracked ammonia fuel) to be provided by a single fuel supply and, for example, from a single ammonia fuel tank. This may be advantageous in terms of volume constraints insofar as a single fuel reservoir is required instead of multiple. Alternatively, the main combustion chamber and the cracking device could be provided with ammonia fuel from two or more different ammonia fuel supplies.

This ammonia fuel inlet could be provided via a number of different configurations. In one example, the ammonia fuel inlet may be configured to introduce ammonia fuel into the main combustion chamber via the precombustion chamber and the orifice. An ammonia fuel inlet configured to introduce ammonia fuel through the precombustion chamber may share similar aspects to the above-discussed example in which the cracked fuel inlet was configured to introduce cracked fuel to the main combustion chamber through the precombustion chamber. For example, the ammonia fuel inlet may be configured to promote an ammonia fuel flow path toward the orifice so as to facilitate introduction of the ammonia fuel into the main combustion chamber. The ammonia fuel inlet may be configured to deliver a flow rate or total volume of ammonia fuel into the precombustion chamber which is configured to fuel the main combustion chamber.

In a particular example, the ammonia fuel inlet is positioned at the precombustion chamber. The precombustion chamber may therefore comprise a cracked fuel inlet and an ammonia fuel inlet. The precombustion chamber may therefore be said to be a multi-inlet precombustion chamber. One or both of the cracked fuel inlet and the ammonia fuel inlet could comprise an electronic fuel injector. In some embodiments, the main fuel inlet and the ammonia fuel inlet are positioned adjacent to one another at the precombustion chamber.

The provision of a ‘multi-inlet’ precombustion chamber may be particularly advantageous in applications where cylinder space (or housing space in the case of a rotary engine) is limited insofar as it allows for cracked fuel and an ammonia fuel to both be introduced via the precombustion chamber and thus avoiding the need for a separate ammonia fuel inlet positioned elsewhere on the cylinder or housing. In instances where an engine system is undergoing conversion to include a precombustion chamber, a multi-inlet precombustion chamber may allow for the precombustion chamber to be fitted where the original fuel intake was located and for two fuel types to be provided to a engine system which was originally designed for a single fuel type.

In an alternative example, the ammonia fuel inlet may be configured to introduce ammonia fuel into the main combustion chamber via the engine system intake. The ammonia fuel inlet may be positioned at the intake (for example, the intake port) of a cylinder or a rotary engine housing. The ammonia fuel inlet could be positioned upstream of the intake. For example, the ammonia fuel inlet could be configured to deliver ammonia fuel to an inlet manifold supplying air-fuel mixture to one or more cylinders.

In a particular embodiment, the cracked fuel inlet or a supply line leading to the cracked fuel inlet may be provided with a non-return check valve. In a particular embodiment, the ammonia fuel inlet or a supply line leading to the ammonia fuel inlet may be provided with a non-return check valve. In another embodiment, the ammonia fuel inlet is configured for direct injection of ammonia fuel into the main combustion chamber. For example, the ammonia fuel inlet could directly communicate with the main combustion chamber. The ammonia fuel inlet could comprise an ammonia fuel injector having an outlet positioned at a cylinder head or a wall of the main combustion chamber.

In certain embodiments, the operation of the cracked fuel inlet and/or the ammonia fuel inlet could be independent of the electronic control device. For example, the cracked fuel inlet and ammonia fuel inlet could be mechanically controlled according to engine cycle. The engine could comprise a valve and camshaft arrangement whereby the cracked fuel inlet and ammonia fuel inlet are introduced via valves mechanically actuated by a camshaft or other timing arrangement. In this example, the electronic control device may not necessarily control introduction of fuel into the precombustion chamber but could control operation of the cracking device according to the evaluated hydrogen characteristics. For example, by controlling a heating device associated with the cracking device to adjust performance of the cracking device.

Alternatively, the ammonia fuel inlet could comprise an ammonia fuel injector in communication with the electronic control device and which is controlled by the electronic control device. This configuration may advantageously allow for introduction of the ammonia fuel to be controlled by the electronic control device and as a function of hydrogen characteristics evaluated by the electronic control device.

In a particular embodiment, the electronic control device is configured to control the duration and timing of the introduction of ammonia fuel into the precombustion chamber by controlling operation of the ammonia fuel injector. In configurations where ammonia fuel supplied to the main combustion chamber via the precombustion chamber, the electronic control device may be configured to control introduction of ammonia into the main combustion chamber by controlling the duration and timing of introduction of ammonia fuel into the precombustion chamber. In configurations where ammonia fuel is provided to the main combustion chamber via the engine intake port or via direct injection, the electronic control device may be configured to control introduction of ammonia fuel into the main combustion chamber by controlling introduction of ammonia fuel into those respective locations.

In a particular embodiment, the electronic control device is configured to determine a volume of ammonia to be introduced into the main combustion chamber according to an evaluation by the electronic control device of the amount of hydrogen present in the cracked fuel. This may advantageously allow for combustion performance to be improved or optimised according to the amount of hydrogen available for combustion via introduction of the cracked fuel.

The present disclosure may advantageously control the quantity of hydrogen provided to the precombustion chamber by first evaluating the amount of hydrogen available in the cracked fuel supply. For example, the ratio of cracked fuel introduced to the precombustion chamber to ammonia fuel introduced to the main combustion chamber can be adjusted so as to achieve a desired ratio of hydrogen to ammonia.

It will be appreciated by a person skilled in the art that the preferred amount of hydrogen present in the precombustion chamber depends on a wide variety of factors including the volume of the main and precombustion chambers, engine speed request, engine load, engine temperature or ammonia slip (i.e. unburnt ammonia) present in exhaust gases.

The preferred hydrogen and ammonia ratio could vary considerably depending on the particular engine parameters and also on the operational parameters. The present disclosure provides a principal of general application which a person skilled in the art may use to produce the above-noted advantageous feedback loop between evaluated hydrogen characteristics in the cracked fuel and the introduction of the cracked fuel into the precombustion chamber or the control of the cracking device. The optimal values of precombustion chamber injection timing and duration, main chamber injection timing (in embodiments with a main chamber injector) and duration and ignition timing may vary depending on application.

In a particular embodiment, the electronic control device monitors hydrogen characteristics of the cracked fuel supply to assess if one or more characteristics are within or are outside of a preferred range. In one example, the electronic control device could detect or infer a drop in the concentration of hydrogen present in the cracked fuel supply. In response, the electronic control device may assess whether the drop will cause the ratio of hydrogen in the precombustion chamber to ammonia in the main combustion chamber to fall below a preferred range (which may depend on various engine parameters including temperature, engine load, speed request etc). and, if so, the electronic control device may increase the injection duration of cracked fuel into the prechamber while reduce the amount of ammonia fuel introduced to the main chamber, or control the cracking device to increase concentration of hydrogen, or both, so as to return the ratio to the preferred range to meet the engine load and speed request.

In a particular embodiment, the electronic control device is configured to control the introduction of ammonia fuel into the main combustion chamber and the introduction of cracked fuel into the precombustion chamber according to a target hydrogen concentration. In a particular embodiment, the target hydrogen concentration is 5% to 35%, by volume, of total hydrogen to total combustible fuel introduced in an engine cycle. As discussed in the foregoing, total combustible fuel may be defined according to the following expression:

$${H}_{2} concentration = \frac{{H}_{2}}{{H}_{2} + {NH}_{3}}$$

In other words, hydrogen concentration is the portion of hydrogen fuel and ammonia fuel which is comprised of hydrogen, and disregarding other gases which are not typically combusted in normal engine operation.

In this embodiment, the electronic control device may seek to achieve or maintain the 5%-35% hydrogen concentration. This range may advantageously provide a sufficient amount of hydrogen to ignite the ammonia fuel in the main combustion chamber and without providing an oversupply of hydrogen which can lead to engine damage or overheating, as well as waste the hydrogen supply which is typically less abundant than the ammonia supply.

In certain operational conditions, target hydrogen concentration may be higher than 35%. For example, during cold start and/or during extreme low ambient temperature conditions, the engine system could deliberately target a higher hydrogen fuel concentration for a quicker warmup. Once, the engine system reaches the typical operating temperatures, target hydrogen concentration (for example, 5-35%) may be maintained thereafter.

The electronic control device may be configured to achieve a hydrogen to ammonia concentration within the target range by adjusting the injection duration of the prechamber fuel injector and main chamber fuel injector according to the hydrogen characteristics evaluated by the electronic control unit and the sensor arrangement. In a particular embodiment of the disclosure, the electronic control device determines the volume of ammonia to be introduced into the main combustion chamber as a function of the volume of hydrogen that is available for introduction into the precombustion chamber.

In a particular embodiment, the cracked fuel inlet comprises a cracked fuel injector in communication with and controlled by the electronic control device and wherein, for each engine cycle, the electronic control device undertakes the following sequence of actions:
i. determine an engine operating request;
ii. evaluate via a sensor arrangement the pressure and temperature of hydrogen in the cracked fuel produced by the cracking device;
iii. set the timing and duration of the cracked fuel injector;
iv. set the timing and duration of the ammonia fuel injector; and
v. set the ignition timing of the ignition device.

According to an embodiment, the engine operating request is an engine load request and/or an engine speed request. According to an embodiment, above-mentioned steps iii. And iv. Are set according to the determinations in steps i. and ii. That is, the timing and duration of the main fuel injector and the precombustion fuel injector is set according to the engine load and speed request (for example, received from a sensor associated with the accelerator pedal of an automobile) and according to the indication of the hydrogen properties in the precombustion fuel supply upstream of the precombustion fuel injector, received from the sensor arrangement.

In a particular embodiment, the cracked fuel produced by the cracking device is provided to the cracked fuel inlet without undergoing a separation process. In this regard, the gases mixture output by the cracking device may be compositionally the same mixture which is delivered to the cracked fuel inlet and which is introduced into the precombustion chamber. This provides an advantage over systems in which hydrogen is filtered or separated from a precombustion fuel mixture. An engine according to the present disclosure advantageously does not necessarily require a separation process to be undertaken upstream of the cracked fuel injector. This can reduce engine complexity, weight and cost.

Furthermore, an internal combustion engine system according to the present disclosure may not require a buffer tank between the cracking device and the precombustion chamber. For example, the output of the cracking device may be provided directly to the precombustion chamber via a precombustion fuel line and without an intermediary storage tank between the cracking device and the precombustion fuel inlet. Dispensing with a separation system and/or a buffer tank may advantageously reduce system complexity, weight and cost.

An internal combustion engine system according to the present disclosure may be significantly simplified over existing systems in that a mixture of unseparated cracked fuel comprising hydrogen and non-hydrogen gases can be supplied directly to the precombustion chamber. The cracking device may be configured to partially crack ammonia and whereby the hydrogen concentration in the cracked gas output from the cracking device is in the range of 5%-35%, by volume.

The engine system may be advantageously configured to operate without isolating hydrogen from nitrogen present in the cracked gas which would significantly add complexity to the system. This advantage is provided via the electronic control device which is configured to evaluate a characteristic of the hydrogen present in the cracked fuel using measurements received from the sensor arrangement and to control introduction of cracked fuel into the precombustion chamber according to those evaluated hydrogen characteristics.

A further advantage associated with operating using partially cracked ammonia comprising a hydrogen concentration of 5% to 35% by volume is that the engine system can operate with smaller or less expensive cracking device as compared to an engine system that was dependent on complete ammonia cracking.

A further advantage associated with operating using partially cracked ammonia comprising a hydrogen concentration of 5% to 35% by volume is that such an engine system would result in higher overall efficiency when compared to higher or complete cracking. This is due to lower energy requirements involved in cracking process which typically comprises of energy to heat ammonia to cracking temperature, energy losses involved in cracking process and energy to cool the cracked gas to a lower temperature suitable for injection.

A further advantage associated with operating using partially cracked ammonia comprising a hydrogen concentration of 5% to 35% by volume is that the cracked gas output from the cracking device and which is used as the precombustion fuel, may require less cooling prior to injection or in some instances may avoid the need for cooling together compared to a scenario where higher or complete cracking was used. This can be attributed to reduced tolerance to abnormal combustion events such as pre-ignition and knocking when higher hydrogen concentration was used without cooling.

A further advantage associated with operating using partially cracked ammonia comprising a hydrogen concentration of 5% to 35% by volume is that the engine system can be configured to operate without isolating hydrogen from nitrogen present in the cracked gas. A higher or complete cracking of ammonia would result in higher concentration of nitrogen and may affect engine performance if not separated. Nitrogen acts as a diluent which can reduce the rate of combustion and as a result lower engine efficiency. In addition, NOx (oxides of nitrogen) and N2O emissions may be higher. Therefore, nitrogen separation from the cracked gas may become necessary which would significantly add complexity to the system.

It will be appreciated that the ignition and combustion of the cracked fuel mixture containing hydrogen increases the pressure in the precombustion chamber over the pressure in the main combustion chamber. The ignition of the cracked fuel within the precombustion chamber can create stream of combusting fluid which is squeezed and ejected into the main combustion chamber through the at least one orifice connecting the precombustion chamber to the main combustion chamber.

The stream of combusting fluid produced by ignition of the cracked fuel could comprise a stream of combusting gases or combusting liquids or a mixture thereof. The stream of combusting fluid could comprise a stream of combusting fuel. The stream of combusting fluid could comprise a flame jet. For example, a flame jet emanating from the precombustion chamber and which may contain combusting gases, radicals, burnt and unburnt fuel mixtures. The stream of combusting fluid may aid in faster and more complete combustion of the fuel in the main chamber. The stream of combusting fluid could comprise a flame jet having a flame front. For example, the stream of combusting fluid could comprise a flame front propagating through the stream of combusting fluid. The wake of the flame front may comprise combusted or combusting fluid (or a mixture of fluids). Fluids ahead of the flame front which are injected into the precombustion chamber could comprise uncombusted fuel.

In a particular form of the disclosure, the fluid communication between the precombustion chamber and the main combustion chamber is provided by a single orifice. In a particular form of the disclosure, a plurality of orifices is provided which connect the precombustion chamber to the main combustion chamber. The plurality of orifices could, in a particular example, comprise between 2 to 10 orifices. A particular embodiment may comprise between 4 to 8 orifices. The plurality of orifices may be configured to provide a plurality of combusting fluid streams into the main combustion chamber. This may produce a plurality of combusting fluid streams. The plurality of combusting fluid streams could each be highly turbulent jets of combusting fluid (for example, turbulent flame jets) which ignites fuel present in the main combustion chamber more rapidly as a result of multiple distributed ignition sites.

The disclosed method of combusting cracked fuel comprising hydrogen in the precombustion chamber (as compared to combusting a mixture of hydrogen and ammonia in the main combustion chamber in some previous ammonia-fuelled engine designs) allows for the same power output to be achieved with less hydrogen required. Accordingly, hydrogen consumption is reduced which improves overall engine efficiency. In other words, for the same level of hydrogen fuel consumption rate, the use of a precombustion chamber is considered to provide higher power output with equal if not higher levels of engine thermal efficiency.

In a particular embodiment, the precombustion chamber has a volume of at least 3% of the clearance volume of the cylinder. This may advantageously produce flame jets with sufficiently high enthalpy to combust ammonia in the main chamber successfully. It will be appreciated that the clearance volume is the volume of the main combustion chamber which remains when the piston is at top dead centre (TDC) position i.e. closest to the cylinder head and farthest from the crankshaft.

According to an embodiment of the disclosure, the cracking device in thermal communication with waste heat produced by the engine. According to an embodiment of the disclosure, the cracking device comprises an electric heating element. In a particular embodiment, the cracking device may be heated by waste engine heat in conjunction with an electric heating element. The electric heating unit may advantageously maintain sufficient cracking performance and hydrogen production at low engine temperatures and, for example, at engine start up. The electric heating unit may be in communication with and be controlled by the electronic control unit.

According to a particular embodiment, the precombustion chamber comprises a coating of a catalytic material configured to partially convert ammonia present in the precombustion chamber into hydrogen. The catalytic material may be coated on an internal wall of the precombustion chamber and/or on a surface of the at least one orifice. The use of a catalytic material coating in the precombustion chamber may in some instances operate to supplement hydrogen content within the precombustion chamber.

The ignition device in the precombustion chamber could be any suitable device known to the person skilled in the art. The ignition device could comprise a laser ignition device. The ignition device could comprise a plasma ignition device. The spark plug could, comprise a spark plug in communication with the electronic control device. Said communication may be electronic communication.

In a particular embodiment, the engine further comprises a heating device configured to heat air provided through the engine intake. A heating device may further help to promote or facilitate optimised combustion by introducing heated air through the engine intake and therefore provided a heated air-fuel mixture.

The plurality of sensors could comprise one or more of a pressure sensor, temperature sensor or gas concentration sensor such as an ammonia sensor, hydrogen sensor or nitrogen sensor. The sensor pack could be positioned to take measurements of the cracked fuel output from the cracking device. The sensor arrangement could be positioned in a fuel line connecting an output end of the cracking device to the cracked fuel inlet. The sensor arrangement could comprise a pack of sensors located adjacent one another. The sensor arrangement could comprise sensors located in different parts of the engine system and which are not adjacent to one another. Each sensor in the sensor arrangement may be configured to communicate with the electronic control device.

According to a particular form of the disclosure, the at least one orifice has a diameter of between 0.8 mm to 3.0 mm. In a particular embodiment, the engine system includes a plurality of orifices and each of the orifices has a diameter of between 0.8 mm to 3.0 mm.

In a particular form of the disclosure, the engine system has a cylinder comprising a cylinder head and wherein the precombustion chamber is located on the cylinder head. It will be appreciated that the position of the precombustion chamber could vary depending on engine design, cylinder geometry and the unoccupied volume available to locate the precombustion chamber. It is therefore to be appreciated that the precombustion chamber could have alternative spatial positioning.

In a particular form of the disclosure, the engine comprises a cracked fuel buffer tank upstream of the fuel inlet and configured to buffer the supply of cracked fuel provided to the fuel inlet.

It will be appreciated that an engine system according to the present disclosure could typically comprise a plurality of cylinders. In an embodiment of the disclosure, the engine comprises a plurality of cylinders and each cylinder in the plurality of cylinders include a main combustion chamber and precombustion chamber.

According to an embodiment of this disclosure, the engine further comprises a compressor device configured to compress cracked fuel upstream of the precombustion chamber. In a particular embodiment, the compressor device is configured to compress the cracked fuel to a pressure not exceeding 100 bar. The compressor device may be controlled by the electronic control device. The compressor device may be used to increase the pressure of the cracked gas being output from the cracking device and to a pressure which may enable desirable injection parameters to be achieved. For example, in a particular embodiment the compressor device is configured to compress the cracked fuel to a pressure which permits choked flow across the cracked fuel injector.

It will be appreciated that achieving choked flow at the nozzle of the precombustion fuel injector produces sonic fuel velocity at the throat (i.e. the narrowed portion of the nozzle) and may also achieve a region of supersonic flow immediately downstream of the throat. This is beneficial in generating a high level of turbulence in the precombustion chamber and, in turn, improves combustion efficiency. Furthermore, choked flow encourages a constant and steady mass flow rate across the injector nozzle thus enabling better control over injection duration.

During choked flow, Hydrogen injection mass is related to pressure and temperature as per the following equation:

$$\dot{m} = {c}_{d} {A}_{n} {P}_{o} \sqrt{\frac{γ M}{{zRT}_{o}} {( \frac{2}{γ + 1} )}^{\frac{γ + 1}{γ - 1}}}$$

Where \dot{m} is the mass flow rate, Aₙ is the nozzle flow area, Pₒ and Tₒ are upstream stagnation pressure and temperature, γ is the specific heat ratio of the gas, M is the molecular weight of the gas, R is the universal constant, z is the compressibility factor and C_{d} is the discharge coefficient of the nozzle.

As will be appreciated from this function, mass flow is related to both pressure and temperature. In particular, mass flow is related directly to pressure and inversely to square root of temperature. Compared to a supply from a pressurised tank such as a hydrogen gas tank, the cracked fuel supply from the cracking device may typically be less steady in terms of pressure, temperature and hydrogen concentration due to variation in temperature, cracking efficiency, etc. Accordingly, measuring or evaluating at least some of these characteristics of the cracked fuel provides a significant advantage in the operation of an engine fuelled by an ‘in situ’ cracked fuel supply. In particular, measurement of pressure and temperature can enable evaluation of mass flow rate from which the electronic control device can set preferred injection parameters.

The use of choked flow may allow for evaluation of the injection mass flow into the precombustion chamber without requiring evaluation of the pressure differential between the cracked gas fuel pressure and the precombustion chamber pressure. This may advantageously reduce physical complexity because a precombustion chamber pressure sensor is not required and, furthermore, may reduce computational load for the electronic control unit because injection mass flow rate can be predicted without requiring a real-time data stream from a precombustion chamber pressure sensor in order to evaluate pressure differential between the precombustion fuel and the precombustion chamber pressure.

The use of choked flow may advantageously allow for a relatively low-pressure cracked gas injection system to be used which may typically reduce expense and complexity. In a particular embodiment of an engine system according to this disclosure, the timing of injection of cracked gas into the precombustion chamber is delayed as much as possible while maintaining choked flow during the period of injection. This may advantageously allow for higher concentration of cracked gas in the precombustion chamber at the time of ignition. In some instances, this may advantageously produce a stream of combusting fluid (for example, a stream of combusting fuel which may comprise one or more flame jets) with higher enthalpy and subsequently faster combustion of main ammonia fuel in the main chamber. In an alternative scenario where flow is not choked, controlling the injection mass during the period of injection may be more complex and even when a precombustion pressure sensor is used to evaluate pressure differential.

It should be appreciated that controlling precombustion chamber injection to achieve choked flow may advantageously increase certainty with respect to the mass flow rate associated with the injection. This is particularly advantageous when operating the engine system of the present disclosure using partially cracked ammonia fuel and, in particular, a precombustion fuel comprised cracked gases comprising 5%-35% hydrogen by volume. It will be appreciated that the required precision when injecting a precombustion fuel of relatively lower hydrogen concentration may typically increase in order to ensure sufficient hydrogen feed to the precombustion chamber. In contrast, injection precision may typically be less important in alternative engine systems which use significantly higher concentrations of hydrogen as precombustion fuel. However, as discussed in the foregoing, such systems suffer from the drawback of requiring larger or more efficient (and more expensive) cracking devices and/or the drawback of requiring a separation system to increase hydrogen concentration and/or the drawback of a hydrogen tank and the associated complexity, cost and weight.

Accordingly, embodiments of the disclosure in which the electronic control device evaluates pressure and temperature of the cracked fuel may advantageously allow for accurate control of hydrogen injection through choked flow conditions. The accurate control, in turn, facilitates repeatable precombustion chamber ignition which facilitates consistent streams of combusting fluid entering the main combustion chamber from the precombustion chamber. The consistent combustion streams may comprise less variation in flame enthalpy and flow pattern. This may facilitate repeatable combustion of the ammonia fuel, helping to improve engine efficiency, emissions and reduce hydrogen requirements.

In a particular embodiment, the electronic control device is configured to increase an injection duration of cracked fuel into the precombustion chamber to inject a required amount of hydrogen to meet high power demand situations or in cold start conditions. This may be performed using the evaluated characteristics of hydrogen present in the cracked fuel supply. The control device can also be programmed to accept the hydrogen percentage in the fuel mixture as an input. This may be used, for example, in embodiments where a consistent fuel mixture was used.

It will be appreciated that the disclosed internal combustion engine could comprise various types of internal combustion engine and including reciprocating engines, rotary engines, etc. Reciprocating engines include but are not limited to traditional piston engines, crank-less, opposed-piston and free-piston engines.

According to another aspect of this disclosure, there is provided a method of operating an ammonia-fuelled internal combustion engine which comprises a precombustion chamber in fluid communication with a main combustion chamber.

The method may comprise one or more of
i. operating a cracking device fed with an ammonia fuel supply to produce a cracked fuel comprising a mixture of hydrogen and nitrogen;
ii. introducing a fuel into the main combustion chamber;
iii. introducing the cracked fuel from the cracking device into the precombustion chamber;
iv. igniting the cracked fuel in the precombustion chamber to produce a stream of combusting gases entering the main combustion chamber from the precombustion chamber to ignite the fuel present in the main combustion chamber; and
v. controlling the introduction of cracked fuel into the precombustion chamber (and/or control operation of the cracking device), using information received from a sensor arrangement associated with the cracked fuel or the cracking device.

In an embodiment, the mixture of hydrogen and nitrogen further comprises uncracked ammonia. The cracked fuel may therefore comprise a partially cracked fuel comprising a mixture if hydrogen, nitrogen and uncracked ammonia. In an embodiment, the fuel introduced into the main combustion chamber comprises cracked fuel from the cracking device. In this instance, the main combustion chamber could be fuelled through the precombustion chamber in the manner discussed in the foregoing.

Alternatively, the fuel introduced into the main combustion chamber could comprise ammonia fuel from the ammonia fuel supply. In this instance, the main combustion chamber could be fuelled through the precombustion chamber in the manner discussed in the foregoing. For example, the precombustion chamber could comprise an ammonia fuel injector adjacent to the cracked fuel injector. Alternatively, the main combustion chamber could be fuelled via the intake or via direct injection of ammonia fuel into the main combustion chamber.

In any embodiment of this method, the sensor comprises a pressure sensor and the method comprises receiving from the pressor sensor an indication of cracked fuel pressure being supplied to the fuel inlet. In an embodiment, the electronic control device may determine whether the cracked fuel pressure supplied to the fuel inlet is less than 10 bar and, if so, the method may comprise commencing the introduction of cracked fuel into the precombustion chamber during an intake stroke of the cylinder. This may advantageously allow for introduced fuel to be ‘sucked’ into the main combustion chamber due to the reduced pressure in the main combustion chamber which occurs during the intake stroke. It is envisaged that a cracked fuel pressure of less than 10 bar might occur according to the output pressures expected of a typical cracking device. The electronic control device may also commence the introduction of cracked fuel into the precombustion chamber during when pressures are still relatively low during beginning of the compression stroke.

In an embodiment, if the electronic control device determines that cracked fuel pressure supplied to the fuel inlet is greater than 10 bar, the method may comprise commencing the introduction of cracked fuel into the precombustion chamber during a compression stroke of the cylinder. It is envisaged that a precombustion fuel pressure upstream of the precombustion fuel inlet of greater than 10 bar might occur where a pressurised precombustion fuel supply was used and, for example, a pressurised hydrogen tank.

In some instances, injection of the cracked fuel may be delayed during the compression stroke until a predetermined level of compression within the precombustion chamber is reached. This may advantageously reduce the time for turbulence within an injected spray of cracked fuel to dissipate and therefore maximises turbulence at the time of ignition and thereby may improve combustion efficiency. Furthermore, a delayed cracked fuel injection may typically reduce piston compression work and thereby increase net work output.

According to a particular embodiment of this method, the sensor comprises a precombustion chamber pressure sensor and the method comprises:
i. receiving an indication of pressure in the precombustion chamber and the method comprising during the compression stroke of the cylinder; and
ii. completing introduction of precombustion fuel into the precombustion chamber before the precombustion chamber pressure reaches a predetermined percentage of the pressure of cracked fuel supplied to the cracked fuel inlet as measured upstream of the fuel inlet.

In an embodiment, the indication of pressure in the precombustion chamber is provided by the precombustion pressure sensor. In an embodiment, the predetermined percentage is 50%. This method selects an injection timing such that the precombustion chamber pressure during the period of injection stays less than half of the cracked fuel supply pressure and which may promote choked flow to occur, which is advantageous for the reasons discussed below.

In an embodiment, the fuel inlet comprises a fuel injector and the method comprises the step of injecting fuel into the precombustion chamber during a compression stroke of the cylinder and wherein cracked fuel injection timing is selected to provide a choked flow condition across the cracked fuel injector. In a particular embodiment, the electronic control device operates the precombustion fuel injector so as to maintain a choked flow condition across the precombustion fuel injector for the entire period of injection. It will be appreciated that the precise pressure drop across the precombustion fuel injector that is required to achieve choked flow may vary depending on specific flow and fluid parameters. However, in many instances choked flow at the nozzle of the precombustion fuel injector may be assumed where pressure upstream of the nozzle is greater than twice the pressure downstream of the nozzle.

In a particular embodiment, the cracked fuel which is output by the cracking device may be of relatively low pressure and, for example, in the range of 5 to 10 bar. In this instance, the engine system of the present disclosure may be configured to achieve choked flow by timing precombustion chamber injection when the precombustion chamber pressure is equal or less than half of the precombustion fuel pressure. In an example where the precombustion fuel output by the cracking device is 5 bar the electronic control unit may be configured to time the precombustion fuel injection when the precombustion chamber pressure is at 2.5 bar or less.

The electronic control device may be configured for precombustion fuel injection to occur when the precombustion chamber pressure is near or at a minimum level of the cycle. The electronic control device may be configured for precombustion fuel injection to occur immediately prior to or concurrent with intake valve closure. The electronic control device may be configured to complete injection prior to the precombustion chamber pressure reaching 50% of the cracked fuel pressure. This may advantageously ensure that all of the precombustion fuel injection occurs under choked flow conditions and thereby avoiding a part-choked, part-unchoked injection which could reduce injection predictability and controllability.

The precombustion chamber injection timing may be set on the basis of real-time measurement precombustion chamber pressure. In particular, the timing may be set so as to achieve choked flow injection based on data received from the precombustion chamber pressure sensor.

Alternatively, the precombustion chamber injection timing may be set on the basis of predetermined values of precombustion chamber pressure which are stored in the system and available to the electronic control device. It will be appreciated that the engine system of the present disclosure need not necessarily require real time measurement of precombustion chamber pressure to produce choked flow injection. The electronic control device may store predetermined precombustion chamber pressure values as a function of engine cycle. In a low-pressure precombustion fuel injection scenario, the electronic control device may be configured to determine when choked flow can be achieved by having regard to predetermined values of precombustion chamber pressure.

In a particular embodiment, the method further comprises:
i. evaluating pressure in the cracked fuel upstream of the fuel injector using real-time measurement of cracked fuel pressure by the sensor associated with the cracked fuel;
ii. evaluating pressure in the precombustion chamber using either predetermined values of precombustion chamber pressure or from real-time measurements of precombustion chamber pressure from a precombustion chamber pressure sensor;
iii. commencing the introduction of the cracked fuel into the precombustion chamber via the cracked fuel injector when the pressure in the cracked fuel upstream of the cracked fuel injector is at least twice pressure within the precombustion chamber.

In a particular embodiment of this method, the electronic control device is configured to have completed the fuel injection into the precombustion chamber before pressure in the precombustion chamber reaches half of the pressure of the fuel being supplied to the precombustion chamber.

An embodiment of this method comprises the step of determining cracked fuel injection timing based on real-time measurement of pressure in the cracked fuel produced by the cracking device and on pre-determined values of pressure inside the precombustion chamber. The precombustion chamber pressure may be pre-determined and stored in the electronic control device as a function of engine operating conditions. For example, the electronic control device may calculate or retrieve a presumed precombustion chamber pressure based on engine operating conditions such as engine load, speed, temperature etc.

Alternatively, the method may comprise the step of determining precombustion fuel injection timing based on real-time measurement of pressure in the cracked fuel produced by the cracking device and on real-time measurement of pressure inside the precombustion chamber. For example, the method could comprise the step of the electronic control device receiving an indication of precombustion chamber pressure from a precombustion chamber pressure sensor.

In a particular embodiment, the introduction of the ammonia fuel into the main combustion chamber via the ammonia fuel injector may commence immediately before the stream of combusting fluid enters the main combustion chamber from the precombustion chamber such that a portion of the ammonia fuel injection period overlaps with the period of entry of the combusting fluid stream(s). The introduction of the ammonia fuel into the main combustion chamber via the ammonia injector may occur via a single continuous injection. Alternatively, the introduction of the ammonia fuel into the main combustion chamber via the ammonia fuel injector may occur via multiple injections or ‘split’ injections. That is, a particular quantity of injected ammonia fuel could be staggered across two or more discrete injection events.

A particular embodiment provides a method which comprises:
i. introducing a first spray of ammonia fuel into the main combustion chamber prior to the stream of combusting gases entering the main combustion chamber from the precombustion chamber; and
ii. introducing a second spray of ammonia fuel into the main combustion chamber after said first spray of ammonia fuel is substantially combusted in the main combustion chamber.

In a particular embodiment, the method comprises the step of commencing and completing a spray of ammonia fuel into the main combustion chamber prior to the stream of combusting gases entering the main combustion chamber from the precombustion chamber. The timing of the combusting fluid stream entering the main combustion chamber may depend on a number of parameters such as ignition timing, engine load and speed, turbulence, etc. The timing may be pre-determined using advanced optical visualisation techniques as a function of these parameters and may be stored in the electronic control device. The timing of combusting fluid stream(s) may also be predicted based on precombustion chamber pressure. The pre-determined values as a function of engine load and speed may be stored in the electronic control device and recalled by the electronic control device when determining values such as the ammonia fuel injection timing.

According to an embodiment, the step of introducing fuel into the main combustion chamber forms an air-fuel mixture which, during a compression stroke of the engine, at least partially flows from the main combustion chamber to the precombustion chamber. This ‘backflow’ comprising of air-fuel mixture flowing into the precombustion chamber from the main combustion chamber may advantageously supply the precombustion chamber with air in the air-fuel mixture and which facilitates combustion of the cracked fuel within the precombustion chamber.

According to another aspect of this disclosure, there is provided an internal combustion engine system comprising: a cylinder comprising a main combustion chamber, an intake and an exhaust; a precombustion chamber in fluid communication with the main combustion chamber via at least one orifice, the precombustion chamber comprising a fuel inlet connected to a fuel supply and configured to permit introduction of fuel from the fuel supply into the precombustion chamber and, via the orifice, to the main combustion chamber; an ignition device positioned with the precombustion chamber and configured to ignite fuel present in the precombustion chamber, wherein the precombustion chamber and/or the orifice are configured to permit production of a stream of combusting fluid entering the main combustion chamber via the orifice from the precombustion chamber to permit ignition of the fuel present in the main combustion chamber; and an electronic control device configured to control the ignition device and to control introduction of fuel through the fuel inlet into the precombustion chamber.

This aspect of the disclosure advantageously allows for fuelling of the main combustion chamber via the precombustion chamber. For example, the main combustion chamber may be supplied with a dose of combustible fuel through the orifice connecting the main combustion chamber with the precombustion chamber. The fuel introduced into the main combustion chamber via the precombustion chamber may therefore be uncombusted and non-ignited. The main combustion chamber may therefore be supplied with non-combusted fuel prior to the stream of combusting fluid entering the main combustion chamber and which causes the non-combusted fuel present in the main combustion chamber to become ignited.

This configuration may advantageously allow for both the precombustion chamber and the main combustion chamber to be fuelled through one or more inlets at the precombustion chamber. According to this aspect of the disclosure, the main combustion chamber can be supplied with combustible fuel through an orifice connecting the precombustion chamber to the main combustion chamber. This may advantageously avoid the need for a separate fuel inlet to deliver fuel to the main combustion chamber. Fuelling the main combustion chamber via the precombustion chamber may avoid the need for a separate fuel injector located at the cylinder intake ports (port injection) or on the cylinder head (direct injection). This configuration may be particularly advantageous for two-stroke engines where there a risk of fuel slip during exhaust scavenging.

According to a particular embodiment, the electronic control device is configured to introduce fuel into the precombustion chamber at a fuel flow rate which permits fuelling of the main combustion chamber. The desired fuel flow rate may be selected by the electronic control device by varying the injection pressure and/or varying the flow area of the injector, for a given engine load and speed request.

The stream of combusting fluid produced by ignition of the fuel could comprise a stream of combusting gases or combusting liquids or a mixture thereof. The stream of combusting fluid could comprise a stream of combusting fuel. The stream of combusting fluid could comprise a flame jet. For example, a flame jet emanating from the precombustion chamber and which may contain combusting gases, radicals, burnt and unburnt fuel mixtures.

In a particular embodiment, the fuel inlet may comprise a fuel injector. In a particular embodiment, the fuel injector may be configured as a variable flow rate fuel injector. In a particular embodiment, the electronic control device may be configured to adjust the flow rate of the fuel injector. In a particular embodiment, the electronic control device may vary an electronic actuation waveform (for example, current or voltage waveforms) by which the movement of the injector needle can be varied. In this manner, the electronic control device may adjust the flow area across the injector and may, in turn, adjust the flow rate of the injector. The method of control may apply, for example, when the fuel injector is configured to allow change in geometric area according to injector needle movement. In a particular embodiment, the electronic control device is configured to control injection pressure via an electronic pressure regulator.

In this aspect of the disclosure, the main combustion chamber may be fuelled with the same fuel type that is ignited in the precombustion chamber. In a particular embodiment, the fuel present in the main combustion chamber and the fuel present in the precombustion chamber at the time of ignition are provided through the same fuel inlet and from the same fuel supply. The fuel may be a hydrogen-containing fuel. Alternatively, the fuel may be any other fuel or mixture of fuels suitable for use with a precombustion chamber.

In alternative embodiment, the fuel present in the main combustion chamber is different to the fuel present in the precombustion chamber at the time of ignition. The fuel which is combusted in the precombustion chamber may be a relatively high-reactivity fuel and the fuel which is combusted in the main combustion chamber may be a lower-reactivity fuel. An example of a lower-reactivity fuel may be an ammonia fuel. Examples of higher-reactivity (i.e. higher than ammonia) fuels may include hydrogen, gasoline, diesel, natural gas, LPG, ethanol and methanol. It will be appreciated that a mixture of these fuels could also be used.

In an embodiment, the precombustion chamber comprises an ammonia fuel injector configured to introduce an ammonia fuel through the precombustion chamber and through the orifice into the main combustion chamber and wherein the engine further comprises a precombustion fuel injector connected to a supply of precombustion fuel comprised at least partially of hydrogen, the precombustion fuel injector configured to introduce the precombustion fuel into the precombustion chamber and wherein the ammonia fuel injector and the precombustion fuel injector are in communication with and are controlled by the electronic control device. This configuration may advantageously utilise the higher reactivity properties of hydrogen as a precombustion fuel to produce an energetic stream of combusting hydrogen entering the main combustion chamber via the orifice from the precombustion chamber and in order to enhance the combustion of the ammonia fuel in the main combustion chamber.

In an embodiment, the precombustion fuel injection and ammonia fuel injection and ignition device are controlled by the electronic control device such that, at the time of ignition, the hydrogen mass is higher in the precombustion chamber than the hydrogen mass in the main combustion chamber.

The precombustion fuel may be provided by a pressurised hydrogen tank. Alternatively, the hydrogen-containing precombustion fuel may be formed ‘in situ’ by a cracking device. According to an embodiment, the engine further comprises a cracking device connected to the ammonia fuel supply and configured, during operation of the engine, to produce a cracked fuel comprising a mixture of nitrogen and hydrogen by cracking of an ammonia fuel provided by the ammonia fuel supply and wherein the precombustion fuel comprises the cracked fuel received from the cracking device. This may advantageously provide a hydrogen-containing precombustion fuel supply which is produced from the same ammonia fuel supply that is used to fuel the main combustion chamber.

In a particular embodiment, the electronic control device is configured to control injection timing and duration of the ammonia fuel injector and the precombustion fuel injector to permit, during operation, a hydrogen concentration in the precombustion chamber that is higher than a hydrogen concentration in the main combustion chamber. The electronic control device may therefore be advantageously configured for economical use of the hydrogen supply or hydrogen-containing fuel, which may typically be less abundant than the ammonia fuel.

According to a particular embodiment, the electronic control device is in communication with a fuel sensor associated with the fuel supply and wherein the electronic control device is configured to control introduction of the fuel through the fuel inlet according to measurements received from the fuel sensor. This may advantageously provide a fuel feedback loop and permitting the electronic control device to optimise fuel introduction based on fuel characteristics which may vary during engine operation. Example of these varying characteristics may include fuel pressure, fuel temperature and in the case of precombustion fuel being provided from a cracking device, varying concentration of gases in the cracked fuel produced by the cracking device.

In a particular embodiment, the electronic control device is configured to control introduction of fuel based on a pre-determined indication of precombustion chamber pressure and based on a real-time measurement of fuel pressure provided by the fuel sensor. The precombustion chamber pressure may be pre-determined and stored in the electronic control device as a function of engine operating conditions. For example, the electronic control device may calculate or retrieve a presumed precombustion chamber pressure based on engine operating conditions such as engine load, speed, temperature etc. This may advantageously avoid the need for a precombustion pressure sensor and thereby reducing the number of overall sensors required for operation.

In an alternative embodiment, a precombustion pressure sensor may be used. For example, the electronic control device may be configured to control introduction of fuel based on a real-time measurement of precombustion chamber pressure and a real-time measurement of fuel pressure.

The engine according to this aspect may further comprise a compressor device configured to compress cracked fuel upstream of the precombustion chamber. In a particular embodiment, the compressor device is configured to compress the cracked fuel to a pressure below 100 bar. The compressor device may be configured to increase the pressure of the fuel supplied to the precombustion fuel inlet to facilitate a choked flow across the precombustion fuel inlet. In embodiments where the precombustion fuel inlet comprises a nozzle such as a precombustion fuel injector, the compressor device may be configured to compress the precombustion fuel to a pressure which permits choked flow across the nozzle. The compressor device may be controlled by the electronic control device.

In an embodiment, the internal combustion engine system comprises an intensifier injector. The intensifier injector may comprise a fuel injector configured for gaseous fuel to be compressed during injection using a hydraulically actuated piston. In some embodiments, this configuration may advantageously increase fuel pressure without requiring a compressor device. The intensifier injector may be controlled via high-speed hydraulic controls which control fuel injection timing, rate and amount. The intensifier injector or a hydraulic control device associated with the intensifier injector may be electronically controlled by the electronic control unit.

An aspect of the disclosure may relate to a power generation system which comprises an internal combustion engine system according to any one of the above-discussed embodiments.

According to another aspect of this disclosure, there is provided a method of fuelling an internal combustion engine which comprises a precombustion chamber in fluid communication with a main combustion chamber via an orifice, the method comprising: introducing fuel into the main combustion chamber by injecting fuel into the precombustion chamber with injection parameters configured to create a fuel flow path from the precombustion chamber through the orifice and into the main combustion chamber.

In an embodiment, the injection parameters comprise at least one of injection mass flow rate, injection pressure and injection timing.

In an embodiment, the fuel is provided from a fuel supply and the method further comprises:
i. measuring one or more characteristics of the fuel supply using one or more fuel sensors associated with the fuel supply; and
ii. communicating the measured fuel supply characteristics to an electronic control device in communication with and the sensor and which is configured to control the introduction of fuel into the precombustion chamber;
iii. using the electronic control device to determine the injection parameters based on the measured fuel supply characteristics.

In an embodiment of this disclosure, the injection parameters comprise injection timing and injection duration. The measurements communicated from the one or more fuel sensors comprises may comprises at least one of the pressure and temperature of the fuel supply. The measurements communicated from the one or more fuel sensors may also comprise compositional information about the fuel supply. For example, in instances where a hydrogen-containing fuel mixture was used as the fuel, the measurements communicated from the one or more fuel sensors could comprise hydrogen concentration.

In an embodiment, the fuel introduced into the main combustion chamber via injection into the precombustion chamber comprises a main combustion chamber fuel, and wherein the method comprises the step of, introducing into the precombustion chamber a precombustion fuel having a different composition to the main fuel. For reasons discussed in the foregoing, this may advantageously allow for the use of a higher-reactivity fuel to facilitate the combustion of a lower-reactivity fuel.

In an embodiment, the introduction of the precombustion fuel into the precombustion chamber commences after introduction of the main combustion chamber fuel into the main combustion chamber. In some embodiments, the main combustion chamber fuel comprises an ammonia fuel and the precombustion chamber fuel comprises a hydrogen-containing fuel. The hydrogen-containing fuel may be at least partially supplied from a hydrogen tank.

In an embodiment of this aspect, the method further comprising:
i. providing an ammonia fuel supply;
ii. operating a cracking device fed by the ammonia fuel supply to produce a cracked fuel comprising a mixture of hydrogen and nitrogen; and
iii. providing the cracked fuel produced by the cracking device to the precombustion chamber for use as the hydrogen-containing fuel.

In a particular embodiment, the ammonia fuel introduced to the main combustion chamber is provided by the ammonia fuel supply which feeds the cracking device. This may advantageously allow for multiple fuel types to be used which originate from a single ammonia fuel supply such as an ammonia fuel tank which feeds both the main combustion chamber and the cracking device.

According to a further aspect of this disclosure, there is provided a method of modifying an internal combustion engine cylinder comprising:
i. fitting a precombustion chamber to the cylinder comprising connecting a downstream end of the precombustion chamber to a fuel inlet of the cylinder to provide fluid communication between the precombustion chamber and a main combustion chamber inside the cylinder, and the precombustion chamber comprising an ignition device configured to, during operation, permit ignition of fuel inside the precombustion chamber; and
ii. connecting a fuel supply to a fuel inlet of the precombustion chamber;

This aspect of the disclosure may advantageously allow for conversion of a conventional internal combustion engine cylinder to use a precombustion chamber, for improved engine performance. The precombustion chamber could comprise a precombustion chamber described in any of the preceding embodiments of this disclosure.

In a particular embodiment, the precombustion chamber may be configured to, during operation, introduce fuel into the main combustion chamber via the precombustion chamber. The precombustion chamber used in this method of modification allows for fuelling of the main combustion chamber via the precombustion chamber. This may advantageously allow for the precombustion chamber to be fitted onto an existing cylinder fuel inlet and for both the precombustion chamber and the main combustion chamber to be fuelled via a single fuel inlet.

In another embodiment, the cylinder may comprise a main chamber fuel injector configured for introducing fuel into the main combustion chamber via an intake port in communication with the main combustion chamber or via direct injection into the main combustion chamber.

The above-disclosed method of modifying an engine to include a precombustion chamber may further comprise modifying a cylinder head of the cylinder to accommodate the precombustion chamber. The method may further comprise connecting the precombustion chamber to a cracking device configured to provide the precombustion chamber with a supply of cracked fuel comprising hydrogen and ammonia. The method may further comprise fitting additional components which could include an ammonia supply tank, pumps, an evaporator, heat exchangers, a cracked gas injector, a new ignition system. The method may further comprise installing an electronic control device or remapping an existing electronic control device with maps for ignition timing, injection durations and injection timings as a function of engine load and speed and which may optionally be optimised for reduced emissions and efficiency.

The precombustion chamber could be configured with a single fuel inlet. In this embodiment, the precombustion chamber and the main combustion chamber may be fuelled by the same fuel type. Combustion of the single fuel type may be enhanced by the use of a precombustion chamber which may produce one or more streams of combusting fluid extending from the precombustion chamber into the main combustion chamber and promoting improved combustion of the fuel present in the main combustion chamber.

The precombustion chamber could be configured with two inlets wherein one fuel inlet is configured for use with a relatively low-reactivity fuel and the other fuel inlet is configure for use with a higher reactivity fuel. Examples of suitable lower and higher reactivity fuels are discussed in the foregoing but may include, for example, an ammonia fuel and a hydrogen-containing fuel. The use of a ‘multi-inlet’ precombustion chamber may allow for two fuel types to be provided to a cylinder which was originally designed for a single fuel type. The method according to this aspect of the disclosure may advantageously allow for a diesel engine to be converted to an ammonia-fuelled engine with a precombustion chamber fuelled by a hydrogen-containing fuel to promote combustion of an ammonia fuel provided to the main combustion chamber of the cylinder.

It will be appreciated that an engine according to this disclosure is not necessarily limited to use with a cracking device. Some embodiments of this disclosure could operate using a different hydrogen source for the precombustion fuel. For example, in an embodiment of the disclosure, the supply of precombustion fuel is at least partially obtained from a hydrogen storage tank. In a particular embodiment, the precombustion fuel comprises at least 90% hydrogen by volume.

The use of a hydrogen tank or similar pressurised vessel may advantageously allow for the precombustion fuel to be supplied at a high-pressure injection (approximately 100-200 bar) or a low-pressure injection (approximately 5-50 bar). It is envisaged that low-pressure injection may be desirable in some applications due to increased cost-effectiveness. It is envisaged that high-pressure injection could provide gains in thermal efficiency, and which is discussed in further detail in subsequent paragraphs.

In a particular form of the disclosure, the precombustion fuel injection may be configured to perform both high-pressure injection and low-pressure injection. This may advantageously allow for high-pressure injection to occur when a hydrogen tank is sufficiently full and for low-pressure injection to occur as the hydrogen tank becomes depleted.

For example, when the hydrogen tank pressure is greater than a high-pressure injection range, the precombustion fuel injector could be operated at a set pressure within that range. When the hydrogen tank pressure drops below the high-pressure injection range, the injector could be operated at tank pressure such that the injection pressure correlates with tank pressure as the hydrogen tank is depleted.

According to a particular embodiment, a hydrogen pressure regulator used in the fuel line to control the precombustion fuel pressure feeding the precombustion fuel injector, according to a preferred operating pressure. In a particular embodiment, a hydrogen pressure and temperature sensor can be integrated into a regulator module. The module may thereby function in a feedback loop thus enabling precise control of hydrogen injection quantity and good combustion stability.

In embodiments of the disclosure where a hydrogen tank is used (and therefore hydrogen concentration in the precombustion fuel supply is less likely to vary) it will be appreciated from the foregoing that the precombustion fuel supply sensor is advantageous in that it can provide real-time measurement of precombustion fuel pressure which allows the electronic control device to determine optimum precombustion fuel injection timing and duration based on a particular engine load and speed request.

According to a particular embodiment, the precombustion fuel comprises a mixture of hydrogen and methane and said mixture comprising at least 50% hydrogen by volume. For example, the engine may include a precombustion fuel tank containing premixed hydrogen/methane mixture such as hythane.

According to an embodiment of this disclosure there is provided an ammonia-fuelled internal combustion engine system comprising: a cracking device connectable to an ammonia fuel supply and configured, during operation of the engine, to produce a cracked fuel comprising a mixture of nitrogen and hydrogen by cracking of an ammonia fuel provided by the ammonia fuel supply; a main combustion chamber, an intake and an exhaust each in fluid communication with the main combustion chamber; a precombustion chamber in fluid communication with the main combustion chamber via at least one orifice, the precombustion chamber further comprising a cracked fuel inlet to permit introduction of the cracked fuel, supplied from the cracking device, into the precombustion chamber; an ignition device operatively positioned with the precombustion chamber and configured to ignite the cracked fuel in the precombustion chamber, wherein the precombustion chamber and/or the orifice are configured to produce a stream of combusting fluid from the precombustion chamber to the main combustion chamber via the orifice, when cracked fuel is ignited in the precombustion chamber, so as to permit ignition of fuel present in the main combustion chamber; a sensor arrangement configured to measure properties of the cracked fuel; an electronic control device in communication with the sensor arrangement and with the ignition device, the electronic control device configured to evaluate a characteristic of the hydrogen present in the cracked fuel using measurements received from the sensor arrangement and to control introduction of cracked fuel into the precombustion chamber according to those evaluated hydrogen characteristics.

According to another aspect of the present disclosure, there is provided an ammonia-fuelled internal combustion engine comprising: a main combustion chamber, an intake valve, an exhaust valve and a main fuel injector connected to a supply of ammonia fuel and configured to introduce the ammonia fuel to the main combustion chamber; a precombustion chamber in fluid communication with the main combustion chamber via at least one orifice, the precombustion chamber comprising a precombustion fuel injector connected to a supply of precombustion fuel comprised partially of precombustion fuel and an ignition device configured to ignite precombustion fuel introduced into the precombustion chamber via the precombustion fuel injector and wherein said ignition in the precombustion chamber produces a flame jet entering the main combustion chamber via the least one orifice to facilitate or cause ignition of the ammonia fuel in the main combustion chamber; and an electronic control device in electronic communication with the main fuel injector, the precombustion fuel injector and with a precombustion fuel sensor configured for measuring properties of the precombustion fuel supply, the electronic control device configured to control operation of the main fuel injector and precombustion fuel injector according to an indication of the precombustion fuel properties received from the precombustion fuel sensor.

The engine according to the above-described aspect of this disclosure is advantageously configured to operate the precombustion fuel injector and the main injector based on an indication of the properties of the precombustion fuel. The precombustion fuel sensor may be configured to provide a real-time indication of precombustion fuel properties which helps to inform optimised injection of the main and precombustion fuels into the main and precombustion chambers respectively. In this way, the precombustion fuel injection, main fuel injection and the ignition timing can be optimised according to real-time properties of the precombustion fuel.

The precombustion fuel sensor may be configured to provide a real-time indication of precombustion fuel at a location upstream of the precombustion fuel injector. The precombustion fuel sensor may be configured to provide a real-time indication of precombustion fuel pressure. The precombustion fuel sensor may be configured to provide a real-time indication of precombustion fuel temperature. The precombustion fuel sensor may be configured to provide a real-time indication of precombustion fuel hydrogen concentration. The precombustion fuel sensor may be configured to provide a real-time indication of precombustion fuel pressure and temperature and hydrogen concentration.

According to an embodiment, the electronic control device controlling the volume of hydrogen introduced into the precombustion chamber via the precombustion fuel injector and the volume of ammonia introduced into the main combustion chamber via the main fuel injector and wherein the electronic control device controls the main fuel injector and precombustion fuel injector such that the ratio of said hydrogen volume to said ammonia volume is within a preferred range.

According to an embodiment, the electronic control device is configured to introduce a volume of hydrogen into the precombustion chamber via the precombustion fuel injector that is 5% to 25% a volume of ammonia introduced into the main combustion chamber via the main fuel injector. According to an embodiment, the electronic control device determines the volume of ammonia to be introduced into the main combustion chamber as a function of the volume of hydrogen that is available for introduction into the precombustion chamber. According to an embodiment, the precombustion fuel sensor configured to measure the concentration pressure and temperature of hydrogen in the precombustion fuel supply.

According to an embodiment, for each engine cycle, the electronic control device undertakes the following sequence of actions: determine an engine load and an engine speed request; determine via the precombustion fuel sensor the pressure, temperature and concentration of hydrogen in the precombustion fuel supply; set the timing and duration of the precombustion fuel injector; set the timing and duration of the main fuel injector; and set the ignition timing of the ignition device in the precombustion chamber. According to an embodiment, the engine further comprising a catalytic cracking device in fluid communication with the precombustion fuel injector, the catalytic cracking device being fed with an ammonia fuel supply and wherein the supply of precombustion fuel is obtained from the catalytic cracking device and comprises a mixture of hydrogen and nitrogen. According to an embodiment, the mixture of nitrogen and hydrogen obtained from the catalytic cracking device is provided to the precombustion fuel injector without undergoing a separation process.

According to an embodiment, the mixture of hydrogen and ammonia obtained from the catalytic cracking device comprises at least 50% hydrogen by volume. According to an embodiment, the catalytic cracking device is fed by the supply of ammonia fuel that is connected to the main injector. According to an embodiment, the precombustion fuel sensor is configured to detect hydrogen properties in the mixture of hydrogen and ammonia obtained from the catalytic cracking device. According to an embodiment, the catalytic cracking device in thermal communication with waste heat produced by the engine.

According to an embodiment, the catalytic cracking device comprising an electric heating element. According to an embodiment, the supply of precombustion fuel is at least partially obtained from a hydrogen storage tank and wherein the precombustion fuel comprises at least 90% hydrogen by volume. According to an embodiment, the precombustion fuel comprises a mixture of hydrogen and methane and said mixture comprising at least 50% hydrogen by volume. According to an embodiment, the precombustion chamber comprises a coating of a catalytic material configured to partially convert ammonia introduced into the cylinder into hydrogen. According to an embodiment, the catalytic material is coated on an internal wall of the combustion chamber and/or on a surface of the at least one orifice.

According to an embodiment, the ignition device is a spark plug or a glow plug. According to an embodiment, the at least one orifice has a diameter of between 0.8 mm to 3.0 mm. According to an embodiment, the precombustion chamber is in fluid communication with the main combustion chamber via a plurality of orifices configured to produce a plurality of flame jets in the main combustion chamber. According to an embodiment, the cylinder comprising a cylinder head and wherein the precombustion chamber is located on the cylinder head. According to an embodiment, the volume of the precombustion chamber is at least 3% of a clearance volume of the cylinder. According to an embodiment, a precombustion fuel sensor located upstream of the precombustion fuel injector and wherein the electronic control device receives an indication from the precombustion fuel sensor of the precombustion fuel pressure supplied to the precombustion fuel injector.

According to an embodiment, if the indicated pressure of the precombustion fuel supplied to the precombustion fuel injector is less than 10 bar, the electronic control device commences the introduction of precombustion fuel into the precombustion chamber during an intake stroke of the cylinder and when the intake valve is in an open position. According to an embodiment, if the indicated pressure of precombustion fuel supplied to the precombustion fuel injector is greater than 100 bar, the electronic control device commences the introduction of precombustion fuel into the precombustion chamber during a compression stroke of the cylinder and when the intake valve is in a closed position. According to an embodiment, the electronic control device is configured to receive an indication of pressure in the precombustion chamber from a precombustion chamber pressure sensor and wherein, during the compression stroke of the cylinder, the electronic control device commences the introduction of precombustion fuel into the precombustion chamber when the precombustion chamber pressure reaches half of the indicated pressure of precombustion fuel supplied to the precombustion fuel injector.

According to an embodiment, the engine further comprises a precombustion fuel buffer tank upstream of the precombustion fuel injector and configured to buffer the supply of precombustion fuel provided to the precombustion fuel injector. According to an embodiment, the electronic control device is configured to inject precombustion fuel into the precombustion chamber during a compression stroke of the cylinder and wherein precombustion fuel injection timing is selected to provide a choked flow condition across the precombustion fuel injector. According to an embodiment, the electronic control device selects precombustion fuel injection timing based on real-time measurement of pressure in the precombustion fuel supply and on pre-determined values of pressure inside the precombustion chamber. According to an embodiment, the electronic control device selects precombustion fuel injection timing based on real-time measurement of pressure in the precombustion fuel supply and on real-time measurement of pressure inside the precombustion chamber.

According to an embodiment, injection of the precombustion fuel occurs while pressure of the precombustion fuel upstream of the precombustion fuel injector is at least twice pressure within the precombustion chamber. According to an embodiment, the main fuel injector is configured for direct injection of the ammonia fuel into the main combustion chamber. According to an embodiment, a first portion of the ammonia fuel introduced into the main combustion chamber is injected immediately before the flame jet(s) enter the main chamber from the precombustion chamber and wherein a second portion of the ammonia fuel is injected after said first portion is substantially combusted by the flame jet(s) in the main chamber. According to an embodiment, injection of ammonia fuel introduced into the main combustion chamber is completed immediately before the flame jet(s) enter the main combustion chamber from the precombustion chamber. According to an embodiment, the main fuel injector commences injection of ammonia fuel into the main combustion chamber immediately before the flame jet(s) enter the main combustion chamber.

References herein to a ‘real-time’ indication to a ‘real-time’ measurement will be understood as an indication or measurement taken by the sensor during operation of the engine and communicated to the electronic control device. The sensor may typically conduct a periodic measurement of the relevant characteristic at a particular sample rate. The particular sample rate which is need could vary depending on the type of measurement being taken but may typically be selected so as to allow detection of changes in the measured characteristic which occurs during operation of the engine. In a particular embodiment, the precombustion chamber and/or main combustion chamber pressure could be measured in real-time as a function of crank angle and with a resolution of between 1 to 5 degrees. In a particular embodiment, the real-time pressure measurement is taken with a resolution of 1 degree. A real-time measurement of fuel pressure, fuel temperature and hydrogen concentration could be taken using commercially-available sensors and using a resolution typically used in automotive applications. For example, real-time measurements of one or more of fuel pressure, fuel temperature and hydrogen concentration could be taken in a range of once every 1-5 engine cycles. It will be appreciated that engine system according to this disclosure may be implemented using conventional fuel sensors and does not required specialised sensors configured for high sampling rates.

Advantageously, an engine according to this aspect of the disclosure is suitable for use with precombustion fuel containing a mixture of hydrogen and non-hydrogen. This is in contrast with previous engines configured for use with precombustion fuel supplies of relatively high-purity hydrogen and wherein the engine can assume most or all of the precombustion fuel being injected comprises hydrogen. The feedback loop enables operation without necessarily requiring a source of high-purity hydrogen (typically one or more hydrogen tanks) which are bulky, heavy and require periodic replenishment.

The feedback provided by the precombustion fuel sensor in the precombustion fuel supply improves engine robustness and may allow for use with different and varied proportions of hydrogen fuel mixture obtained from sources such as industrial wastes, steam methane reforming, etc. For example, hydrogen can also be blended with other gaseous fuels such as natural gas. The flexibility in tolerating varying levels of purity of hydrogen mixtures offers significant economic advantages.

According to an aspect of this disclosure, there is provided an ammonia-fuelled internal combustion engine system comprising: a cracking device connectable to an ammonia fuel supply and configured, during operation of the engine, to produce a cracked fuel comprising a mixture of nitrogen and hydrogen by cracking of an ammonia fuel provided by the ammonia fuel supply; a main combustion chamber, an intake and an exhaust each in fluid communication with the main combustion chamber; a precombustion chamber in fluid communication with the main combustion chamber via at least one orifice, the precombustion chamber further comprising a cracked fuel inlet to permit introduction of the cracked fuel, supplied from the cracking device, into the precombustion chamber; an ignition device operatively positioned with the precombustion chamber and configured to ignite the cracked fuel in the precombustion chamber, wherein the precombustion chamber and/or the orifice are configured to produce a stream of combusting fluid from the precombustion chamber to the main combustion chamber via the orifice, when cracked fuel is ignited in the precombustion chamber, so as to permit ignition of fuel present in the main combustion chamber; a sensor arrangement configured to measure properties of the cracked fuel and/or the cracking device; an electronic control device in communication with the sensor arrangement and with the ignition device, the electronic control device configured to evaluate a characteristic of the hydrogen present in the cracked fuel using measurements received from the sensor arrangement and to control introduction of cracked fuel into the precombustion chamber according to those evaluated hydrogen characteristics.

### BRIEF DESCRIPTION OF DRAWINGS

In order that the disclosure may be more fully understood, some embodiments will now be described with reference to the figures in which:

FIG. 1 illustrates an engine system according to an embodiment of the disclosure;

FIG. 2 illustrates an alternative engine system to that of FIG. 1 and in which the ammonia fuel injector is configured for direct injection;

FIG. 3 illustrates an embodiment of a precombustion chamber suitable for use with any of embodiments illustrated and described herein;

FIG. 4 illustrates a sequence of actions undertaken by an electronic control device according to an embodiment of the disclosure;

FIG. 5 illustrates an engine system according to a further embodiment of the disclosure;

FIG. 6 illustrates an engine system according to a further embodiment of the disclosure;

FIG. 7 illustrates an alternative embodiment of the engine system shown in FIG. 6 and in which the main fuel injector is configured for direct injection;

FIG. 8 illustrates an engine system according to an alternative embodiment of this disclosure;

FIG. 9 illustrates an engine system according to an alternative embodiment of this disclosure;

FIG. 10 illustrates an engine system according to an alternative embodiment of this disclosure;

FIG. 11 illustrates an engine system according to an alternative embodiment of this disclosure;

FIGS. 12 to 16 illustrate injection and ignition timing diagrams for a variety of engine system embodiments according to this disclosure; and

FIGS. 17 to 23 illustrate exemplary fuel system schematics for use with a variety of engine system embodiments according to this disclosure.

### DETAILED DESCRIPTION

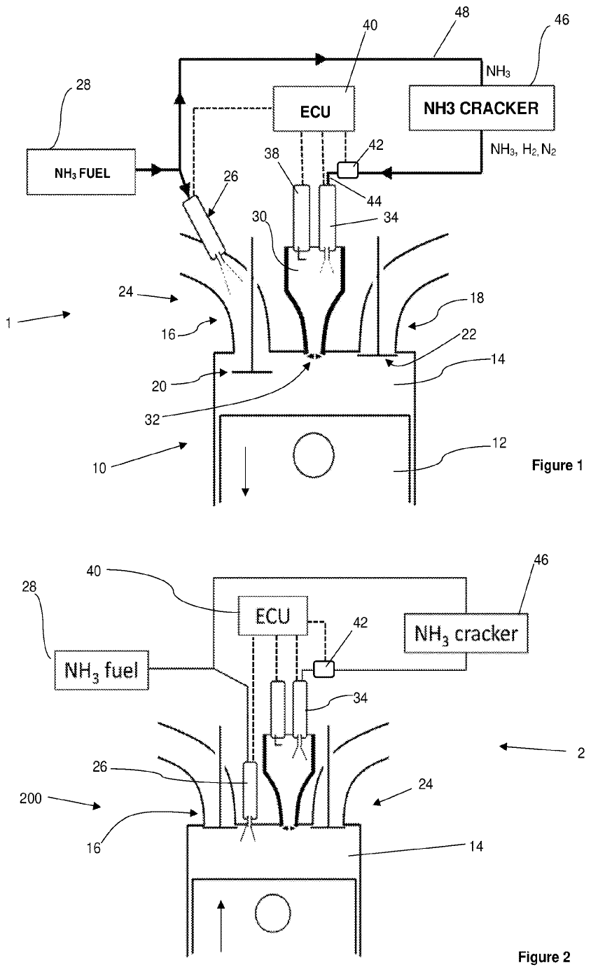

FIGS. 1 and 2 illustrates an ammonia-fuelled engine system 1 according to a first embodiment of this disclosure. The engine 1 has a cylinder 10 comprising a piston 12 within a main combustion chamber 14. The cylinder 10 has an intake comprising intake port 16 and an exhaust comprising exhaust port 18. The intake port 16 and exhaust port 18 are fluidly connected with the main combustion chamber 14 at a cylinder head 24. The intake port 16 and exhaust port 18 are selectively closable by an intake valve 20 and an exhaust valve 22 respectively and which are also located at the cylinder head 24.

A main fuel injector 26 comprising an ammonia fuel injector is located at the intake port 16 and is connected to an ammonia fuel supply 28. The main fuel injector 26 is configured to deliver ammonia fuel to intake port 16 and such that a mixture of ammonia fuel and air is supplied to the main combustion chamber 14, via the intake valve 20. In the illustrated embodiment, this is shown occurring during the intake stroke. However, in some instances, the ammonia fuel could be delivered via the main fuel injector 26 and the intake valve 20 during the compression stroke.

The cylinder 10 further comprises a precombustion chamber 30 located at the cylinder head 24 and in fluid communication with the main combustion chamber 14 via a plurality of orifices 32. The main combustion chamber 14 and the precombustion chamber 30 are in fluid communication (e.g., constant fluid communication) via the plurality of orifices 32. The precombustion chamber 30 further comprises an ignition device comprising, in this example, a sparkplug 38 configured to ignite precombustion fuel delivered to the precombustion chamber 30 via the precombustion fuel injector 34.

The precombustion chamber 30 comprises a fuel inlet which in the FIG. 1 comprises a precombustion fuel injector 34 connected via a precombustion fuel line 44.

The engine system 1 further comprises an ammonia cracking device 46 receiving ammonia fuel from the ammonia fuel supply 28 via an ammonia supply line 48. The spatial positioning if the cracking device 46 could vary. The cracking device 46 could be positioned relatively close to the cylinder 10. For example, both the cracking device 46 and the cylinder 10 could be houses within the engine bay of an automobile. Alternatively, the cracking device 46 could be positioned apart from the cylinder 10. For example, the cracking device 46 could be positioned in outside of the automobile engine bay which houses the cylinder 10. It should be appreciated that cracking device 46 forms part of the same engine system 1 as the cylinder 10 notwithstanding its spatial positioning with respect to the cylinder 10. It will also be appreciated that the engine system 1 need not be an automobile engine and could be used in any power generation device, which may be variable speed/load, or generally fixed speed/load (e.g., gensets, which may or may not be containerised). In some examples, the engines described herein may be used as, for example, automotive engines, maritime engines, power generation units, motorbike engines, aircraft engines, locomotive engines or for any other internal combustion engine application. In some examples, the engines may have power ratings between kWs and MWs.

The output of the ammonia cracking device 46 produced via decomposition is a cracked fuel comprising a mixture of hydrogen and nitrogen. The cracked fuel mixture could also comprise uncracked ammonia, depending on operating conditions of the cracking device (e.g., cracker efficiency). The cracked fuel is delivered via the precombustion fuel line 44 to the cracked fuel injector 34. The cracked fuel is introduced via the precombustion fuel injector 34 into the precombustion chamber 30. The precombustion fuel injector 34, in this embodiment, therefore comprises a cracked fuel injector. The cracked fuel is introduced into the precombustion chamber without any separation or filtration. The cylinder 10 is therefore configured to use a mixture of nitrogen and hydrogen (and potentially also uncracked ammonia) as the precombustion fuel which is introduced into the precombustion chamber 30.

The cylinder 10 is associated with an electronic control device comprising an electronic control unit (ECU) 40 in electronic communication with the main fuel injector 26, the precombustion fuel injector 34 and the sparkplug 38. The ECU 40 forms part of the engine system 1 but, like the cracking device 46, the positioning of the ECU 40 with respect to the cylinder 10 could vary according to the application of the engine system 1.

The ECU 40 is configured to evaluate one or more characteristics of the cracked fuel using measurements received from a sensor arrangement 42 which is associated with the cracked fuel or with the cracking device 46. In the FIG. 1 embodiment, the sensor is part of a sensor pack 42 positioned at the precombustion fuel line 44 upstream of the precombustion fuel injector 34. In particular, the sensor pack 42 is positioned between the cracking device 46 and the precombustion fuel injector 34. The ECU 40 is configured to receive measurements from the sensor pack 42 and to evaluate a characteristic or a property of the cracked fuel supplied to the precombustion fuel injector 34. In a particular embodiment, the characteristics comprise the pressure and temperature of the cracked fuel. In a particular embodiment, the characteristics comprise the pressure and temperature and the hydrogen concentration of the cracked fuel.

The ECU 40 is configured to control introduction of cracked fuel into precombustion chamber 30 by electronically operating the precombustion fuel injector 34. The ECU 40 is configured to introduce sprays of precombustion fuel into the precombustion chamber 30. The ECU is configured to control the duration and timing of the cracked fuel sprays introduced to the precombustion chamber 30. The ECU is further configured to control operation of the main fuel injector 26 and the sparkplug 38 according to the evaluated hydrogen characteristics of the cracked fuel being provided to the precombustion fuel injector 30.

The sensor pack 42 measures properties of the precombustion fuel (e.g., continuously) to determine timing and duration of the main fuel injection and precombustion fuel injection as well as ignition timing. In the FIG. 1 embodiment, hydrogen concentration in the precombustion fuel may with efficiency of the cracking device 46 due to factors such as the temperature of the cracking device 46.

The embodiment illustrated in FIG. 1 is advantageous in that a hydrogen-containing cracked fuel can be produced ‘in situ’ as part of the engine system. Furthermore, the ammonia fuel supply for the main fuel injector 26 and the cracked fuel supply for the precombustion injector 34 are both provided from the same ammonia fuel supply 28. This eliminates the need for a separate supply of hydrogen such as a hydrogen tank. The cracking device 46 can be designed to produce the required quantities of hydrogen on demand depending on the engine load and speed and therefore be directly connected to the fuel system of the precombustion chamber as shown. The energy required for the process can also be obtained advantageously from the exhaust heat of the engine. In a particular embodiment, the ECU 40 actuates the precombustion chamber injector 34 based on the operating pressure of the cracking device 46.

In the embodiment illustrated in FIG. 1, the precombustion fuel injector 34 is shown configured for direct injection into the precombustion chamber 30. However, it should be appreciated that the precombustion fuel injector 34 could, in alternative configurations, be located upstream of the precombustion chamber 30 and connected thereto via a passage. In some alternative embodiments, the precombustion fuel injector 34 is located upstream of the precombustion chamber and is in fluidly communication with the precombustion chamber via a fuel line which comprises a non-return check valve.

The hydrogen and nitrogen mixture (i.e. the cracked fuel) which is output by the cracking device 46 may typically be of relatively low pressure (approximately less than 20 bar). As illustrated in FIG. 1, the precombustion fuel injection may be configured to occur during the intake stroke of the cylinder 10 when the piston 12 is moving downward and the intake valve 20 is in the open position. During the compression stroke, the upward movement of the piston 12 may push some of the mixture of ammonia and air from the main combustion chamber 14 into the precombustion chamber 30. Therefore, at the time of ignition both the main combustion chamber 14 and the precombustion chamber 30 can contain ammonia fuel and hydrogen-containing cracked fuel. The precombustion chamber 30 may contain a higher proportion of hydrogen than the main combustion chamber 14. The differential proportion of hydrogen and ammonia is advantageous wherein the fast-burning hydrogen molecules are surrounded by slow burning ammonia molecules which may result in smoother rate of combustion and pressure rise in both chambers.

Accordingly, the embodiment shown in FIG. 1 exemplifies low-pressure cracked fuel injection into the precombustion chamber 30 and in which the fuel pressure upstream of the precombustion fuel injector 34 may be less than 20 bar. In some cases, the cracked fuel pressure upstream of the precombustion fuel injector 34 may be less than 10 bar. The ECU 40 controls the actuation of the injectors 26, 34 and the ignition device 38. The ECU 40 may receive a real-time measurement of fuel pressure upstream of the precombustion chamber injector 34 from the sensor pack 42. In some configurations, when the measured pressure is approximately 10 bar or less, the ECU 40 actuates the precombustion fuel injector 34 to start the injection of hydrogen-containing cracked fuel during the open period of the intake valve 20, as shown in FIG. 1.

This method of low-pressure injection of cracked fuel into the precombustion chamber 30 may in some instances advantageously allow the injected cracked fuel to diffuse into the main chamber 14 through the orifices 32, depending on the local pressure and velocity and mixing with the main ammonia fuel. The ECU 40 also actuates the main fuel injector 26 located in the intake port 16 to inject ammonia fuel into the main combustion chamber 14 when the intake valve 20 is open as shown in FIG. 1.

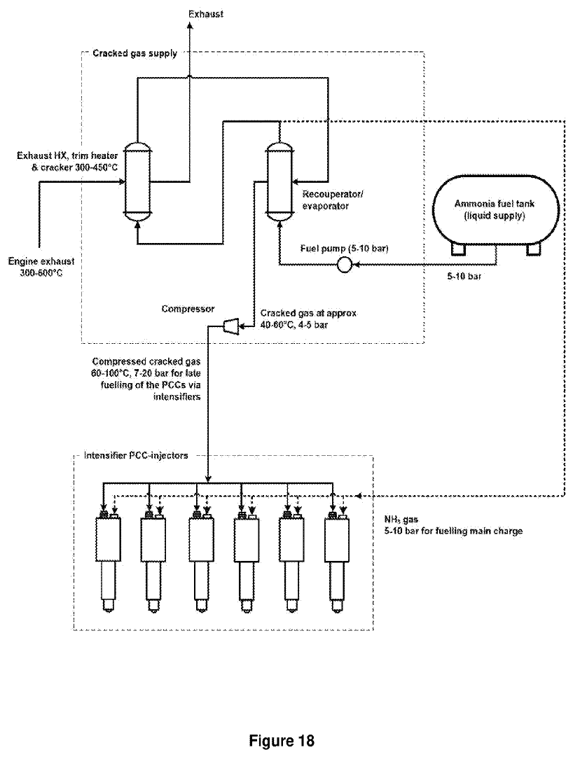

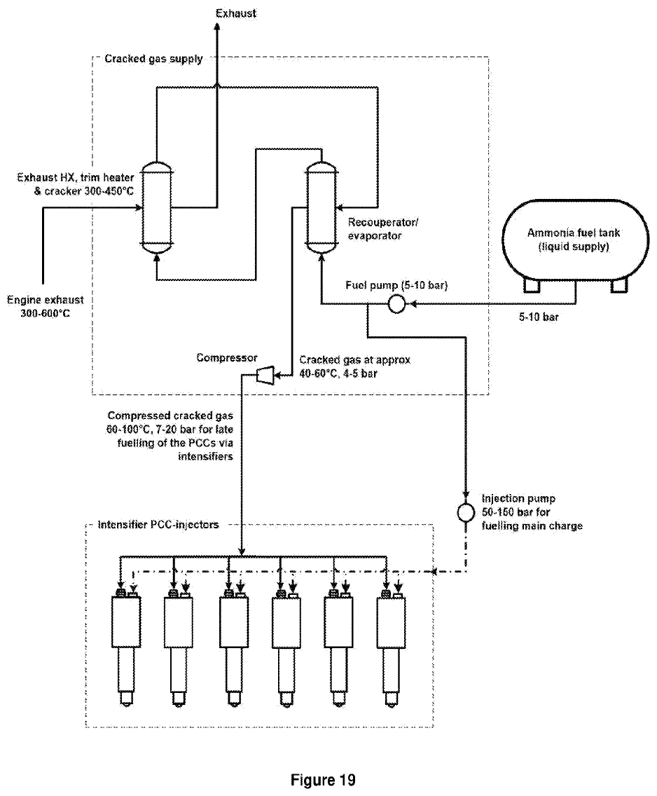

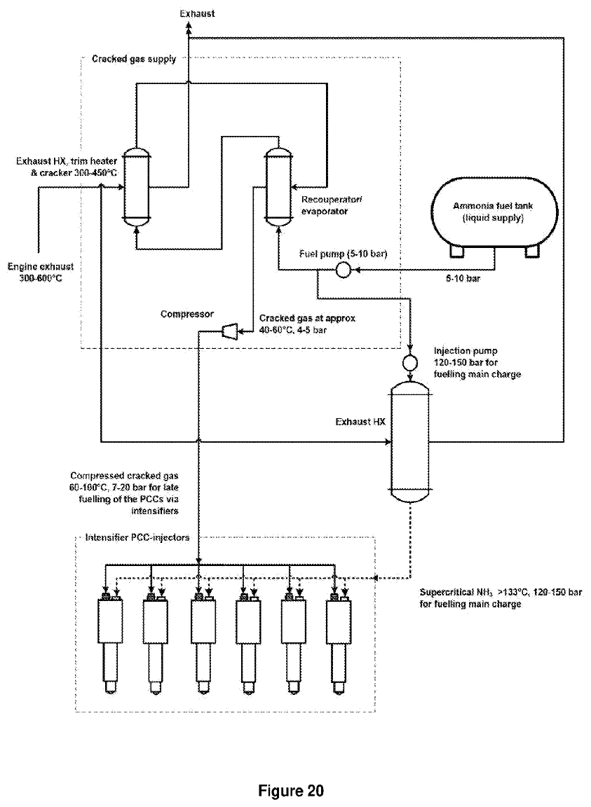

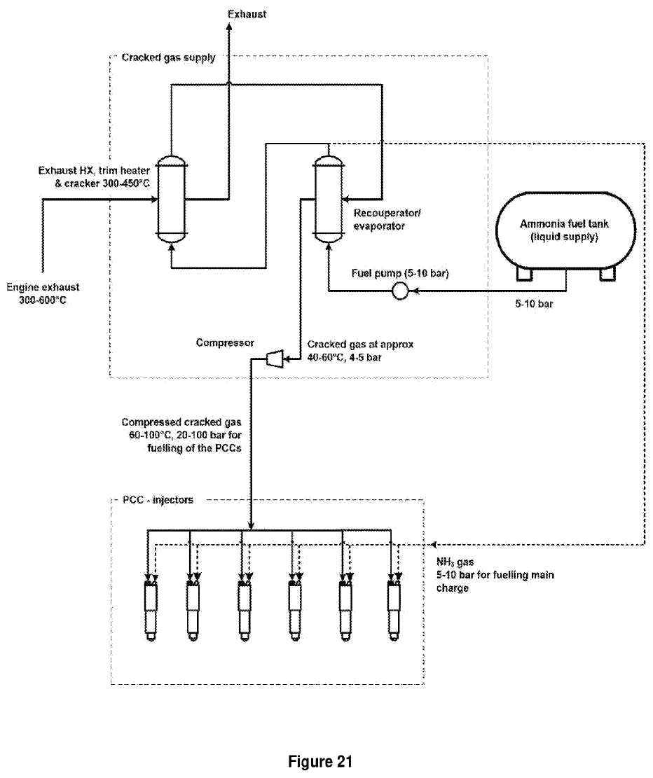

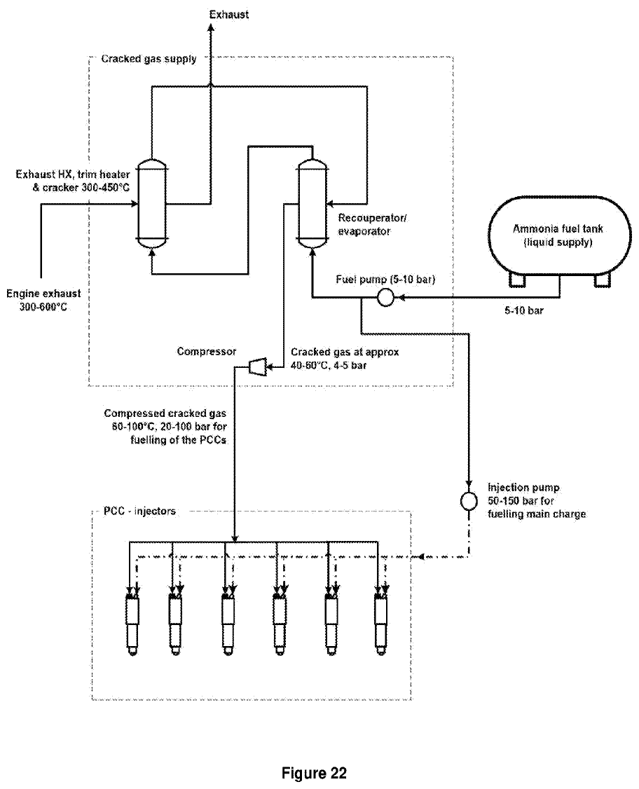

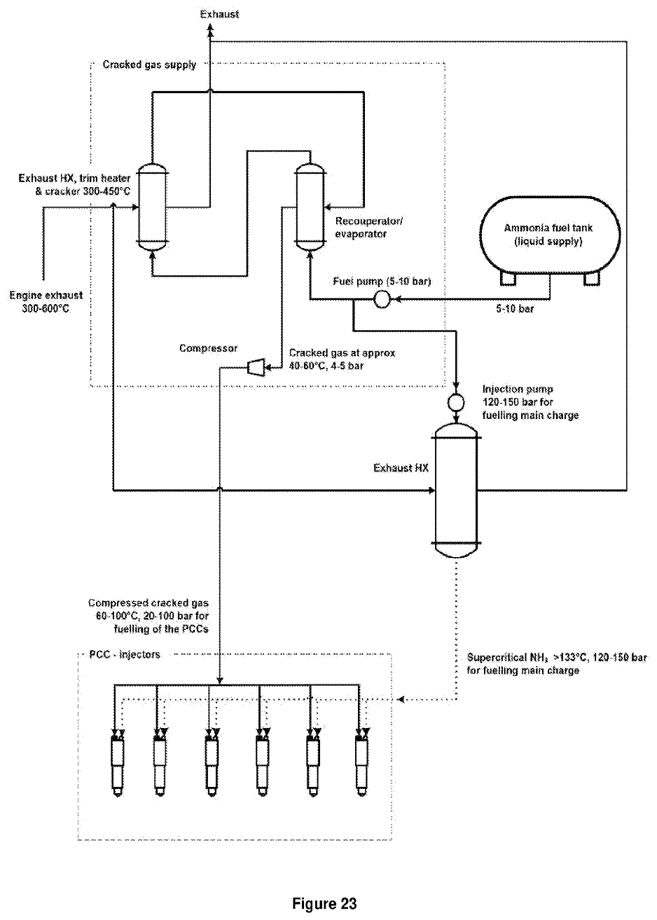

As will be discussed subsequently with reference to FIGS. 6, 8 and 17-23, in some embodiments of this disclosure, the fuel supply to the precombustion chamber may be provided at a higher pressure and in which case the ECU 40 may employ a different injection strategy to the above-described low-pressure injection method. For example, the precombustion fuel supply may be provided by a pressurised tank. Alternatively, the engine system may further comprise a compressor device to increase the pressure of cracked fuel upstream of the precombustion chamber.

Turning to FIG. 2, there is illustrated an engine system 2 comprising a cylinder 200 according to an alternative embodiment of the disclosure. Cylinder 200 is similar to the cylinder 10 illustrated in FIG. 1 except that in cylinder 200, the main fuel injector 26 is configured for direct injection into the main combustion chamber 14. The provision of the main fuel injector 26 as a direct injector may advantageously allow for injection of ammonia fuel directly into the main combustion chamber 14 at any time during the intake and compression stroke of the cylinder.

The main fuel injector 26 of cylinder 200 is located on the cylinder head 24. The main fuel injector 26 is therefore positioned adjacent to the precombustion chamber 30 on the cylinder head 24. In the embodiments illustrated in FIGS. 1 and 2, the main fuel injector 26 is configured to introduce fuel into the main combustion chamber independently of the precombustion chamber 30.

It will be appreciated the intake port 16 of cylinder 200 of FIG. 2 may, during use, be providing air to the main combustion chamber 14 which forms an air-fuel mixture in the main combustion chamber 14 upon injection by the main fuel injector 26. In contrast, the intake port 16 of cylinder 10 in FIG. 1 is providing an air-fuel mixture to the main combustion chamber 14.

According to an embodiment of the disclosure, the ECU 40 is configured to operate the main fuel injector 26 and the precombustion fuel injector 34 so as to introduce a volume of cracked fuel into the precombustion chamber which corresponds to a volume of hydrogen (depending on cracked fuel hydrogen concentration) and to introduce a volume of ammonia into the main combustion chamber, that is with a target range (e.g., during normal operating conditions). In a particular embodiment, the ECU 40 is configured with a target concentration of 5%-35% hydrogen volume to ammonia fuel volume. In a particular embodiment, the target concentration may be 5% to 25%. The volume of hydrogen available for injection into the precombustion chamber 30 is a function of several characteristics of the cracked fuel supply and which may include hydrogen concentration in the precombustion fuel supply and the pressure and temperature of the cracked fuel supply. The ECU 40 can perform an evaluation of one or more of these characteristics using measurements received from the sensor pack 42. The ECU 40 may be configured to determine injector timing and duration based on the evaluated characteristic(s) and in view of the target concentration, which may in some instances be 5%-35%. In particular instances, the target concentration may be 5 to 25%. In some instances, such as during engine warm up, the target concentration may be higher than 35%. For example, a target hydrogen concentration of greater than 35% may be used initially when the exhaust is cold and in order to reach typical engine operating temperature more quickly.

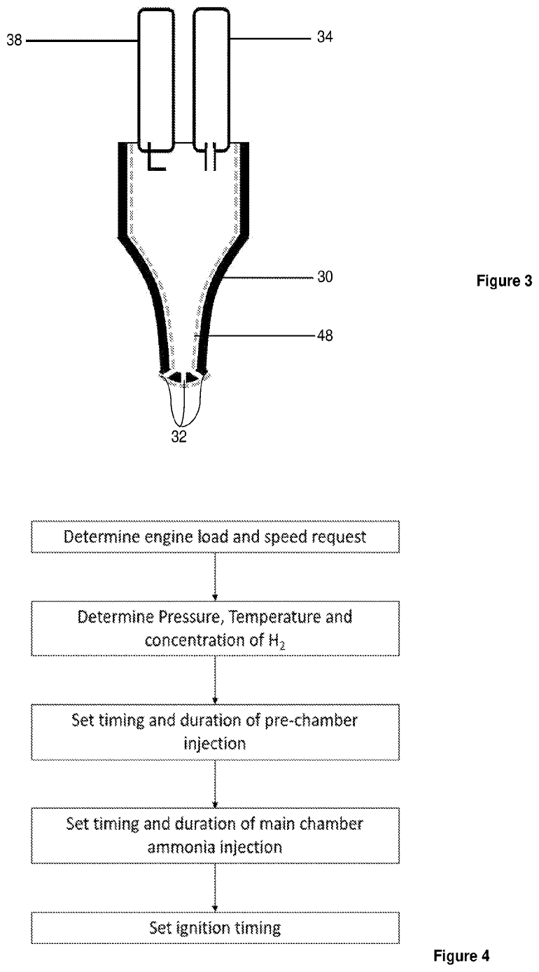

Turning to FIG. 3, there is illustrated an embodiment of the precombustion chamber 30 in which the interior of the chamber 30 and the orifices 32 are provided with a catalytic coating 48. The catalytic coating 48 is configured to generate some additional hydrogen from ammonia present in either the ammonia/hydrogen cracked fuel mixture output from the cracking device 46 and/or from ammonia in the main fuel supply which in some configurations may flow from the main combustion chamber 14 into the precombustion chamber 30. The catalytic coating 48 may operate to slightly increase the concentration of hydrogen present in the precombustion chamber 30 and/or the main combustion chamber 14 at the time of ignition.

Where ammonia is present to the precombustion chamber 30 (either where uncracked ammonia is present in the cracked fuel or where ammonia fuel has passed into the precombustion chamber from the main combustion chamber), the catalytic coating 48 illustrated in FIG. 3 allows for a relatively small quantity of the ammonia present in the precombustion chamber 30 to be partially cracked into hydrogen and nitrogen and thereby improving overall combustion due to the higher-reactivity of hydrogen relative to ammonia. The rate of conversion is temperature dependent and therefore a function of operating load and speed of the engine. The walls of the precombustion chamber 30 and the gas mixture inside it would retain some portion of the heat after a combustion event which would aid in partially decomposing ammonia molecules inducted into the main combustion chamber 14 during the intake stroke and into the precombustion chamber 30 during the upward movement of the piston 12 during compression stroke of the engine cycle. The embodiment of the precombustion chamber 30 illustrated in FIG. 3 may be utilised in any of the different ammonia-fuelled engine system embodiments described herein.

FIG. 4 is a flow diagram illustrating an exemplary sequence of operations performed by the ECU 40.

In an example where the cylinder 10 is part of an automobile engine, the electronic control device can receive load and speed request information via an electronic communication with the accelerator pedal of the automobile. The speed and load request information provides the ECU 40 with a target output for the cylinder and may inform the amount of main fuel required for combustion in order to achieve the desired output.

It will be appreciated that the cylinder 10 could, alternatively, be part of a stationary power-generation engine, a water vessel engine, or any other internal combustion engine application and thus the speed and load request information in those applications will be provided by a component other than an accelerator pedal. For example, in the case of a stationary power-generation engine the speed and/or load request could be a user input which is fed to the ECU 40. In some applications, the ECU 40 could be pre-programmed to operate at fixed load and speed or generate discrete power outputs e.g., low, mid and full power.

Once the engine load and speed request information has been determined, the electronic control device may evaluate the pressure, temperature and concentration of hydrogen present in the precombustion fuel from one or more sensors associated with the cracked fuel supply upstream of the precombustion fuel injector. For example, with the sensor pack 42 illustrated in FIGS. 1 and 2. It will be appreciated that the sensor pack 42 could be located at an upstream side of the precombustion fuel injector 34 or a downstream side of the cracking device 46 or anywhere in the cracked fuel line between the cracking device 46 and the precombustion fuel injector 34. The determination of the hydrogen pressure, temperature and temperature informs the electronic control device of the amount of hydrogen available for use as a precombustion fuel.

The ECU 40 may then set the timing and duration of the precombustion fuel injector 34. It will be appreciated that the duration of the precombustion fuel injection may be selected by the ECU 40 to inject a desired volume of hydrogen into the precombustion chamber 30. The timing of the precombustion fuel injector 34 could depend on various parameters and, for example, could depend on, the pressures measured on either side of the precombustion fuel injector.

In some embodiments such as where a compressor device was used to increase cracked fuel pressure, the cracked fuel could be supplied at relatively high pressure and the precombustion fuel injection may occur during the compression stroke. In this instance, the precombustion fuel injection may be delayed in order to reduce the delay between injection and ignition. This may advantageously maximise the turbulence present within the precombustion fuel chamber (which dissipates with time) to facilitate mixing and enhanced combustion efficiency.

The ECU 40 may then set the timing and during of the main chamber fuel injector 26 in order to inject a desired volume of ammonia fuel into the main combustion chamber 14. Finally, the ECU 40 may set an appropriate ignition timing.

It will be appreciated that the ECU 40 can determine the ignition timing based on pre-determined values and may activate the ignition device such that the hydrogen-containing cracked fuel, when ignited, produces one or more streams of combusting fluid that are ejected into the main combustion chamber 14 through the orifices 32 and ignites the main ammonia fuel mixture in the main combustion chamber 14 successfully. The stream(s) of combusting fluid may comprise flame jets. The ECU 40 may be configured such that if the hydrogen concentration in the precombustion fuel source varies then the amount of main combustion chamber ammonia injection is also commensurately varied such that the total hydrogen and ammonia proportions are maintained within acceptable combustion stability, based on pre-determined values for the requested load and speed.

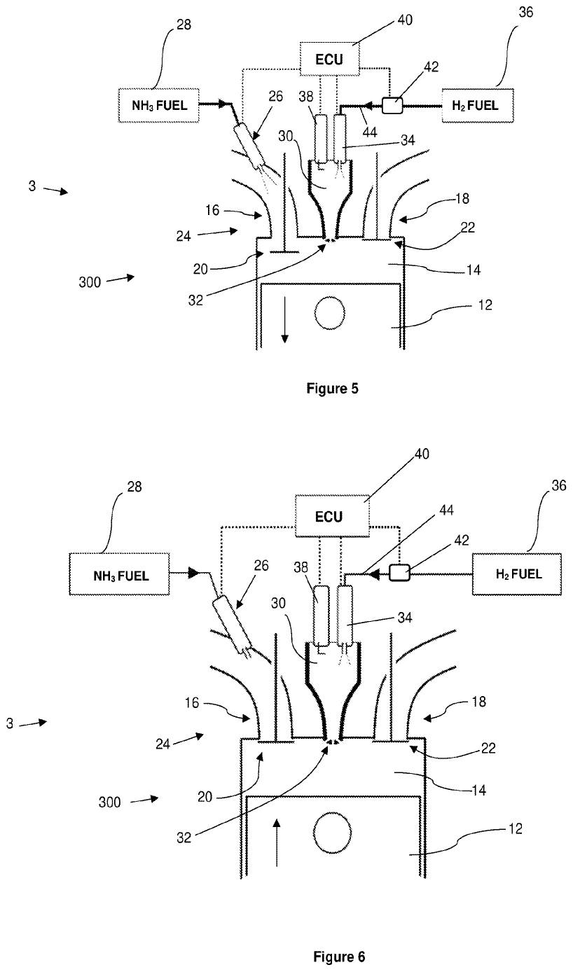

FIGS. 5-7 illustrate alternative embodiments of this disclosure and in which the precombustion injector 34 is supplied with hydrogen-containing precombustion fuel from a precombustion fuel supply 36 other than a cracking device. The precombustion fuel supply 36 could be a hydrogen supply such as a hydrogen tank. In these embodiments, the precombustion injector 34 is provided with a precombustion fuel that is not cracked fuel. In FIGS. 5-7, the injector 34 is not a ‘cracked fuel’ injector and may simply be a precombustion fuel injector. The precombustion fuel injector 34 is supplied with precombustion fuel via precombustion fuel line 44 which connects the precombustion fuel injector 34 with the precombustion fuel supply 36.

FIGS. 5 and 6 illustrate an ammonia-fuelled internal combustion engine system 3 comprising a cylinder 300. FIGS. 5 and 6 illustrate the same mechanical configuration operating in two different fuelling scenarios, and which are dependent on the precombustion fuel pressure in precombustion fuel line 44. The engine system 3 comprises a pressure sensor 42 associated with the precombustion fuel line 44 and configured to communicate precombustion fuel pressure measurements to the ECU 40.

Similar to FIG. 1, FIG. 5 illustrates a scenario where the precombustion fuel pressure is relatively low (for example, less than 10 bar) and wherein the precombustion fuel injection occurs during the intake stroke of cylinder 10 where the piston 12 is moving down and where the intake valve 20 is open. In FIG. 5, the main fuel injector 26 and the precombustion fuel injector 34 are performing fuel injections. i.e. both the main fuel comprising ammonia and the precombustion fuel comprising cracked fuel are sprayed during the intake stroke.

FIG. 6 illustrates an alternative scenario where the precombustion fuel pressure is relatively high (for example, greater than 10 bar) and wherein the precombustion fuel injection occurs during the compression stroke of cylinder 10 where the piston 12 is moving up and where the intake valve 20 is closed. In this scenario, the main combustion chamber 14 has already received ammonia fuel from an earlier intake stroke and thus the precombustion fuel is being injected subsequent to the main fuel injection.

In the scenario illustrated in FIG. 6, the ECU 40 receives an indication of the measured precombustion fuel pressure upstream of the precombustion fuel injector 34 which is around 100 bar or more. In response to this pressure measurement, the ECU 40 actuates the precombustion fuel injector 34 to start the injection of hydrogen-containing precombustion fuel between 90° and 0° before top dead centre (TDC) i.e. during the compression stroke of the engine. This method of high-pressure injection of hydrogen-containing fuel into the precombustion chamber 30 can result in further improvements in thermodynamic efficiency. High-pressure injection of gaseous hydrogen induces significantly high levels of turbulence in the precombustion chamber 30. In addition, the start of injection can be delayed during the compression stroke which means a high degree of turbulence is retained at the time of ignition. As a result, the precombustion chamber 34 contains highly turbulent hydrogen-rich mixture which can be easily ignited thanks to wide flammability limits of hydrogen. This produces highly energetic flame jets through the orifices 32 and combusts ammonia in the main combustion chamber 14 more efficiently.

In either of the low-pressure scenario in FIG. 5 or the high-pressure scenario of FIG. 6, the duration and timing of the main fuel injection and the precombustion fuel injection is determined by the ECU 40 according to information received from the sensor pack 42 which informs the ECU 40 of measured properties of the precombustion fuel.

An alternatively (unillustrated) method of control is to store the hydrogen and nitrogen mixture output from the cracking device 46 into a pressure container with the aid of a compressor. Hydrogen could also be separated from nitrogen through known methods in the art.

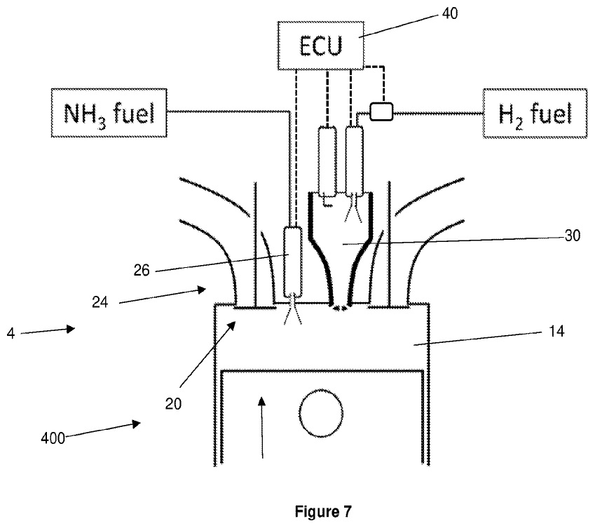

FIG. 7 illustrates an engine system 4 comprising a cylinder 400 according to an alternative embodiment of the disclosure. The engine system 4 and cylinder 400 are equivalent to engine system 3 and cylinder 300 illustrated in FIGS. 5 and 6 except that, with cylinder 400, the main fuel injector 26 is configured for direct injection into the main combustion chamber 14. In particular, the main fuel injector 26 is configured as a direct injector located on the cylinder head 24. As discussed in the foregoing, this may advantageously provide allow for precise or more temporally flexibly ammonia fuel injection insofar as ammonia fuel can be injected into the main combustion chamber 14 at any time during the engine cycle and regardless of the position of intake valve 20. For example, ammonia fuel could be injected into the main combustion chamber 14 during a compression stroke of the engine system 4 when the intake valve 20 is in a closed position.

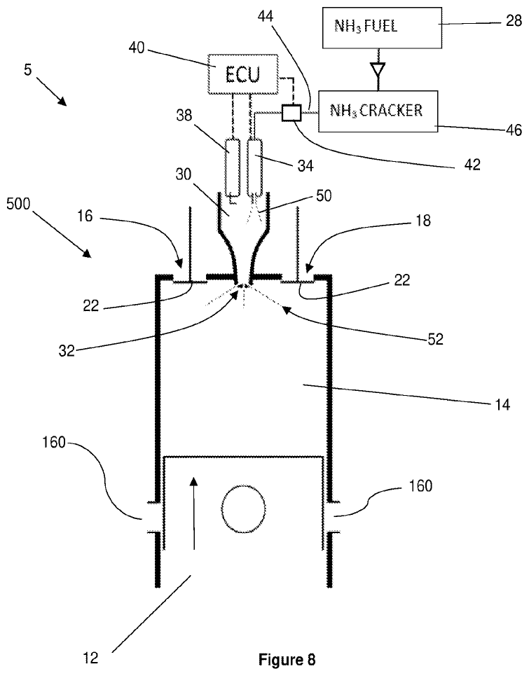

It will be appreciated that the precombustion chamber injection could occur at either low pressure or high pressure, depending on other parameters of the engine system and as described in the foregoing. The ammonia fuel injection provided by the main fuel injector 26 could occur during an intake stroke when the intake valve 20 is open and such as illustrated in FIGS. 1 and 5. Alternatively, the main fuel injection provided by the ammonia fuel injection 26 could occur during a compression stroke of the cylinder when the intake valve 20 is closed, which is the position illustrated in FIGS. 2 and 7. FIGS. 2 and 7 illustrate ammonia fuel and cracked fuel being injected during upward movement of the piston 12 and during a compression stroke of the engine systems 2, 4. FIG. 8-11 illustrates cracked fuel being injected into the precombustion chamber and into the main combustion chamber, via the precombustion chamber, during upward movement of the piston 12 and during a compression stroke of the engine system.

In some embodiments, the ECU 40 may inject ammonia fuel during both the intake and compression strokes. For example, injection of the ammonia main fuel may begin during the intake stoke and inject continuously until ceasing while the cylinder 200 is undergoing the compression stroke. In a particular embodiment of this disclosure, the main fuel injection provided by the main fuel injector 26 could be configured as a split injection. The split injection could comprise two injection events. The first injection event being a discrete injection of main fuel during the intake stroke and the second injection event being a discrete injection of main fuel during the compression stroke.

In a particular embodiment, the split injection of ammonia comprises a first injection occurring immediately before the combusting fluid streams from the precombustion chamber 30 enter the main chamber 14 and then a second injection occurring after the ammonia fuel from the first injection has been substantially combusted by the combusting fluid streams the main chamber 14. It should be appreciated that any of the herein described embodiments could be configured with the above-discussed split injection modes.

In another embodiment, all of the ammonia fuel in the main fuel injection is injected just before the combusting fluid streams from the precombustion chamber 30 enter the main chamber 14. In yet another embodiment the start of the main fuel injection is commenced just before the combusting fluid streams enter the main chamber 14 such that a portion of the main fuel injection period overlaps with the period of entry of the combusting fluid streams. It is considered that all of these embodiments enable quick and rapid combustion as well as reduction in ammonia slip through the exhaust.

Turning to FIG. 8, there is illustrated an internal combustion engine system 5 comprising a cylinder 500 according to an alternative embodiment of this disclosure. The cylinder 500 is configured as a two-stroke engine cylinder comprising a piston 12, an intake comprising a pair of intake ports 160, an exhaust comprising a pair of exhaust ports 18 selectively closable with exhaust valves 22, a main combustion chamber 14 and a precombustion chamber 30 in fluid communication with the main combustion chamber 30 via a plurality of orifices 32. A fuel inlet comprising a cracked fuel injector 34 is provided at the precombustion chamber 30.

The engine system 5 comprises a cracking device 46 connected to an ammonia fuel supply comprising an ammonia fuel tank 28. The cracking device is configured to produce partially cracked fuel comprising a mixture of hydrogen, uncracked ammonia and nitrogen according to a target concentration of hydrogen, relative to the total amount of hydrogen and ammonia present in the cracked fuel. In particular embodiments, the cracking device 46 may be configured to produce a partially cracked fuel which comprises between 5%-35% hydrogen, by volume to that of ammonia.

The cracked fuel is delivered to the cracked fuel injector 34 via a cracked fuel line 44. The cracked fuel injector 34 is configured to inject sprays 50 of cracked fuel into the precombustion chamber 30. The cracked fuel line 44 is provided with a sensor 42 in communication with an electronic control device comprising an ECU 40. The ECU 40 is configured to evaluate a characteristic of hydrogen present in the cracked fuel using measurements received from the sensor 42. The ECU 40 is in communication with and controls operation of the cracked fuel injector 40. The ECU 40 is configured to control introduction of partially cracked fuel into the precombustion chamber 30 according to the evaluated hydrogen characteristics. The precombustion chamber 30 is also provided with an ignition device comprising a spark plug 38 which is in communication with and is controlled by the ECU 40.

The cylinder 500 is configured for the cracked fuel injector 34 to permit introduction of partially cracked fuel into the precombustion chamber and, via the orifices 32, into the main combustion chamber. The cracked fuel flow through the orifices 32 into the main combustion chamber 14 form sprays 52 which supply the main combustion chamber 14 with cracked fuel. The fuel sprays 50 into the precombustion chamber and the fuel sprays 52 into the main combustion chamber therefore both comprise cracked fuel. The cracked fuel present in the main combustion chamber 14 and the cracked fuel present in the precombustion chamber 30 is thereby provided from the same fuel inlet which comprises cracked fuel injector 34. The cracked fuel present in the precombustion chamber 30 is directly provided by the cracked fuel injector 34. The cracked fuel present in the main combustion chamber 14 is indirectly provided by the cracked fuel injector 34 insofar as it is provided via the precombustion chamber 30. The fuel present in the main combustion chamber 14 and the fuel present in the precombustion chamber 30 are thereby provided from the same fuel supply which comprises ammonia fuel tank 28. As will be appreciated, such an arrangement avoids the need to have two or more separate fuel supplies. In some cases, only a single fuel supply (e.g., ammonia supply) may be used.

The ECU 40 is configured to introduce a sufficient quantity of partially cracked fuel into the precombustion chamber 30 and the main combustion chamber 14 to fuel operationally-sufficient combustion within the main combustion chamber 14. Upon fuelling of the main combustion chamber 14 and the precombustion chamber 30, the ECU 40 activates the spark plug 40 to permit ignition of the cracked fuel present in the precombustion chamber. Combusting streams of fuel, which may comprise flame jets, enter the main combustion chamber 14 through the orifices 32 and cause or promote ignition of the cracked fuel present in the main combustion chamber 14.

The ECU 40 may be configured to control injection timing or duration of the partially cracked fuel sprays 50 into the precombustion chamber according to an evaluated characteristic of the cracked fuel such as cracked fuel temperature and/or cracked fuel pressure and/or cracked fuel gas composition.

According to this configuration, the cylinder 500 is configured to fuel both the precombustion chamber 30 and the main combustion chamber 14 using a single fuel inlet (cracked fuel injector 34). This configuration is advantageous insofar as a second fuel inlet associated exclusively with the main combustion chamber 14 is not required. Furthermore, this configuration allows for provision of a two-stroke engine with a precombustion chamber 30 to enhance engine efficiency. The utilisation of the single cracked fuel injector 30 to introduce partially cracked fuel is also advantageous for volume considerations where a cylinder head may have insufficient room to accommodate a separate main combustion chamber injector.

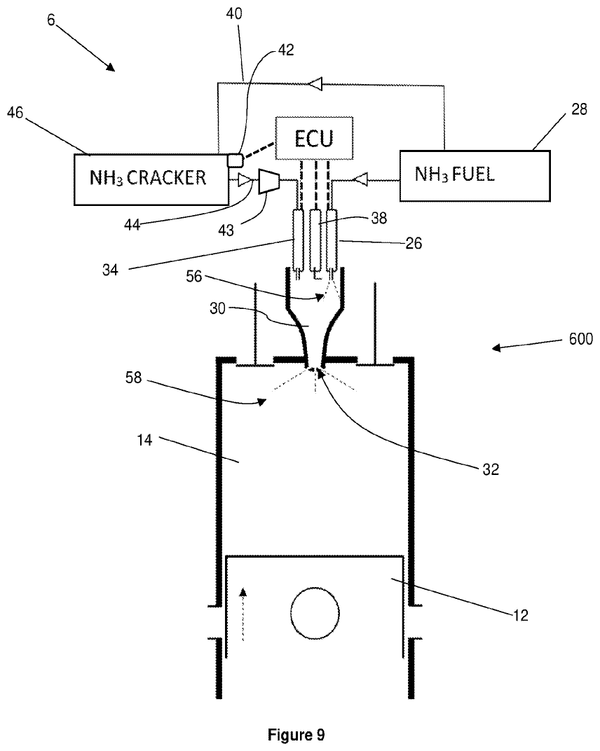

Turning to FIG. 9, there is illustrated a two-stroke internal combustion engine system 6 comprising a cylinder 600 which is similar in configuration to cylinder 500 but further comprises an ammonia fuel injector 26 configured to introduce ammonia fuel to the precombustion chamber 30. The ammonia fuel injector 26 is supplied with ammonia fuel from the ammonia fuel tank 28 which supplies the cracker device 46 which supplies cracked fuel to the cracked fuel injector 34. In this manner, both the cracked fuel injector 34 and the ammonia fuel injector 30 can be supplied from a single ammonia fuel tank 28.

Both the ammonia fuel injector 30 and the cracked fuel injector 34 are positioned at a head of the precombustion chamber 30. In the illustrated embodiment, the ammonia fuel injector 30 and the cracked fuel injector 34 may each be configured for direct injection into the precombustion chamber 30. Alternatively, the two injectors 26, 34 could introduced fuel to port or line in fluid communication with the precombustion chamber and said introduction occurring upstream of the precombustion chamber.

The ammonia fuel injector 26 is configured to introduce ammonia fuel into the main combustion chamber via the precombustion chamber. The ammonia fuel injector may deliver a sufficient quantity of ammonia fuel to the precombustion chamber that ammonia fuel is expelled from the precombustion chamber 30 through the orifices 32. In this manner, the main combustion chamber 14 can be fuelled by ammonia fuel 14 from the ammonia fuel injector 30. The cracked fuel injector 34 then subsequently injects hydrogen-containing cracked fuel into the precombustion chamber 30. The higher-reactivity cracked fuel, upon ignition by the spark plug 38 produces streams of combusting fluid entering the main combustion chamber 14 and causes or promotes ignition and combustion of the lower-reactivity ammonia fuel present in the main combustion chamber 14.

In the embodiment illustrated in FIG. 9, the sensor 42 is not directly associated with the cracked fuel (as was the case in the above-described engine system 5 but is instead associated with the cracking device 46. In particular, the sensor 42 of engine system 6 comprises a temperature sensor 42 associated with the cracking device 46.

Still referring to engine system 6 of FIG. 9, the sparkplug 38, the ammonia fuel injector 26 and the cracked fuel injector 34 are electronically controlled by the ECU 40. The ECU is in communication with a sensor which comprises the temperature sensor 42 associated with the cracking device 46. The ECU 40 is configured to evaluate a characteristic of the hydrogen in the cracked fuel using a temperature measurement received from temperature sensor 42. The ECU 40 is provided with predetermined cracking device performance information as a function of cracking device temperature. The ECU 40 receives real-time measurements of cracking device temperature, retrieves a presumed cracking device performance characteristic based on the measured temperature and evaluates one or more characteristics of the cracked fuel. For example, the ECU 40 may evaluate one or more of hydrogen concentration or pressure or temperature of the cracked fuel using the cracking device temperature measurement received from temperature sensor 42.

The ECU 40 is configured to control introduction of cracked fuel into the precombustion chamber 30 and introduction of ammonia fuel into the precombustion chamber 30, according to the evaluated hydrogen characteristics. The ECU 40 may, for example, determine injection timing and duration of the ammonia fuel injector 26 and the cracked fuel injector 34 according to the evaluated hydrogen characteristics.

The engine system 6 comprises a compressor device 43 configured to increase the pressure of the cracked fuel which is provided to the cracked fuel injector 34. The compressor device 43 may be positioned in the cracked fuel line 44 in a position downstream of the cracking device 46 and upstream of the cracked fuel injector 34. The compressor device may be configured to compress the cracked fuel from a relatively low pressure (~10 bar or less) at an output of the cracking device 46, to a higher pressure. In some embodiments, the higher pressure provided by the compressor device may be up to 100 bar. In some embodiments, the compressor device 43 is electronically controlled by the ECU 40. In some embodiments, the compressor device 43 may be a variable pressure compressor device and the ECU may selectively adjust the cracked fuel pressure provided to the cracked fuel injector 34.

It will be appreciated that the use of the compressor device 43 may advantageously allow for injection of the cracked fuel to occur according to the high-pressure scenario discussed above with reference to FIG. 6. For example, a higher-pressure injection of cracked fuel may induce significantly high levels of turbulence in the precombustion chamber 30. In addition, the start of injection can be delayed during the compression stroke which means a high degree of turbulence is retained at the time of ignition. As a result, the precombustion chamber 34 contains highly turbulent hydrogen-containing mixture which can be easily ignited thanks to wide flammability limits of hydrogen. This may produce highly energetic streams of combusting fluid through the orifices 32 and combusts fuel in the main combustion chamber 14 more efficiently.

Still referring to FIG. 9, ammonia fuel sprays 56 are shown being injected into the precombustion chamber 30. Simultaneously, the ammonia fuel sprays 58 are shown being injected into the main combustion chamber 14 from the precombustion chamber, via the orifices 32. As shown by the directional arrow of the piston 12, this is occurring during a compression stroke of the engine system 6.

In some embodiments, a controllable high-pressure pump device may also be provided upstream of the ammonia fuel injector 26 in order to achieve a desired ammonia fuel pressure upstream of the ammonia fuel injector 26. This may be particularly useful where ammonia is injected in liquid state to perform injection during a compression stroke of the engine.

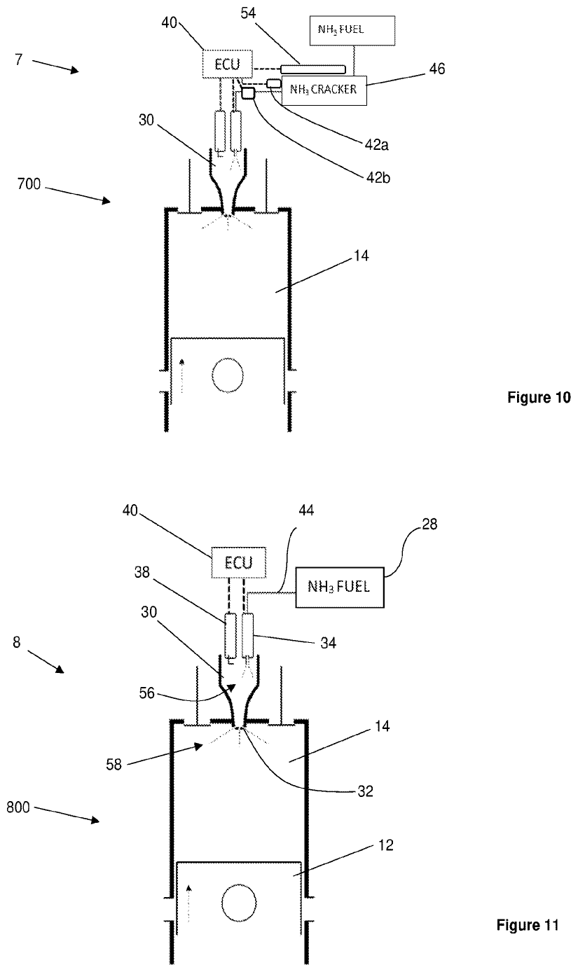

Turning to FIG. 10, there is illustrated a further embodiment in which a two-stroke engine system 7 comprises a cylinder 700 which has a similar configuration to cylinder 500 in FIG. 8 in that cylinder 700 comprises a single cracked fuel injector 34 configured to introduce cracked fuel to both the precombustion chamber 30 and to the main combustion chamber 14. Cylinder 600 differs from cylinder 500 in that the ECU 40 is in communication with a controllable electric heating device 54 which is configured to heat the cracking device 46. The ECU 40 may therefore adjust performance of the cracking device 46 and therefore adjust the composition of the cracked gas produced by the cracking device 46, by controlling the heating device 54. The heating device 54 may advantageously maintain sufficient cracking performance and hydrogen production at low engine temperatures and, for example, at engine start up. The controllable heating device 54 may be utilised with the cracking device 46 in any of the preceding embodiments. The use of a controllable heating device may be advantageous in any embodiment of this disclosure where engine exhaust heat is insufficient to achieve sufficient cracking performance.

The engine system 7 of FIG. 10 has a sensor arrangement which comprises a cracking device temperature sensor 42a and a fuel sensor 42b, both in communication with the electronic control unit 40. The cracking device temperature sensor 42a may be configured to provide the ECU 40 with temperature information relating to the cracking device 46. The fuel sensor 42b may be configured to provide the ECU 40 with fuel information including fuel temperature and pressure.

As noted, the engine system 5 of FIG. 8 and the engine system 7 of FIG. 10 are provided with a single fuel injector which comprises the cracked fuel injector 34. This is in contrast to the engine systems 1, 2, 3 and 4 in FIGS. 1, 2, 5, 6 and 7 where there is provided a cracked fuel injector and a separate ammonia fuel injector. In these embodiments, the hydrogen-containing cracked fuel introduced by the cracked fuel injector can be diluted (leaned) by operation of the ammonia fuel injector. These engine systems may be configured to introduce cracked fuel and ammonia into the cylinder to as to achieve a hydrogen fuel concentration of between 5%-35%.

In contrast, the ‘single injector’ engine systems 5 and 7 illustrated in FIG. 8 are configured such that the fuel mixture introduced and ignited in the cylinder is the same compositional mixture produced by the cracking device. Accordingly, the cracking device 46 in these embodiments may be configured to produce cracked fuel having a hydrogen concentration within a target range. For example, the cracker may be configured to produce cracked fuel having a hydrogen concentration of within 5% to 35%. As discussed in the foregoing, this concentration may be typically suitable for regular and sustained engine operation. Higher hydrogen concentrations may be selected, as needed, during certain conditions such as cold starts and during cold ambient temperatures.

Examples of cracking device control are discussed in the foregoing but may include control over the amount of exhaust gas which is supplied to the cracking device. For example, if the cracking device temperature (and therefore cracking efficiency) is nearing or has exceeded a desired limit such that hydrogen concentration is nearing or has exceeded a desired limit, then exhaust heat may be bypassed from the cracking device. Operation of the exhaust gas bypass may be controlled by the electronic control device. Another example is via control of a controllable heating device, as illustrated in FIG. 10 by heating device 54.

The electronic control device may be configured to selectively lower the heat to the cracking device by temporarily removing a heat source (such as bypassing exhaust gas or turning off or turning down an electronic heating device) from the cracking device, where it is desired to reduce hydrogen concentration. As noted, this may be particularly desirable where a single fuel injector is used. In embodiments where a separate ammonia fuel injector is used then cracking device may operate at maximum cracking efficiency and hydrogen concentration can be diluted to a target range within the cylinder by introduction of ammonia fuel via the ammonia fuel injector.

FIG. 11 illustrates an alternative embodiment of this disclosure in which a two-stroke engine system 8 comprises a cylinder 800. Similar to some previous embodiments, the engine system 8 comprises a main combustion chamber 14, a precombustion chamber 30 in communication with the main combustion chamber via a plurality of orifices 32, an ECU 40, a fuel injector 34 controlled by the ECU 40 and a spark plug 38 controlled by the ECU 40. The fuel injector 34 is configured to directly inject fuel into the precombustion chamber 34 and also to fuel the main combustion chamber 14, via fuelling of the precombustion chamber 30. As shown, sprays of fuel 56 are injected into the precombustion chamber from the fuel injector 34. This causes sprays 58 of the same fuel to enter the man combustion chamber 14 via the orifices 32. The fuel injector 34 is supplied with fuel from a fuel line 44 which receives fuel from a fuel supply 28. In the illustrated embodiment, the fuel supply comprises ammonia fuel 28, though it will be appreciated that other fuel types such as gasoline, diesel, methane, LPG, hydrogen-containing fuel mixtures and others can be used or could be blended or mixed separately so as to improve the combustibility of ammonia

The embodiment in FIG. 11 differs to preceding embodiments in that it does not involve the use of a hydrogen-containing fuel or a fuel sensor communicating measurements to the ECU 40. FIG. 11 exemplifies that the advantageous fuelling system by which the main combustion chamber 14 is fuelled through the precombustion chamber 30, is not necessarily limited to hydrogen-containing fuels and may be utilised with other fuel types and in engines which may or may not be configured to control fuel introduction based on an evaluation of hydrogen characteristics of the fuel.

In an alternative embodiment, the engine system 8 of FIG. 11 is provided with a pressure sensor and/or a temperature sensor in the fuel line 44 to inform the ECU 40 of fuel temperature and/or pressure upstream of the fuel injector 34. The ECU may control fuel injection according to the temperature and/or pressure measurements provided by the sensor.

The embodiment illustrated in FIG. 11 may exemplify a situation where a conventional two-stroke engine has been retrofitted with the precombustion chamber 30 by forming an inlet hole into the cylinder head and fitting the precombustion chamber 30 into the newly formed inlet hole. It will be appreciated that any of the embodiments illustrated and described herein could be achieved by retrofitting a conventional internal combustion engine with a precombustion chamber and that this conversion is not necessarily limited to two-stroke internal combustion engines.

Another (not illustrated) example of converting an engine to include a precombustion chamber is the conversion of a hydrocarbon engine (e.g., diesel engine) which already includes a fuel inlet in communication with the main combustion chamber. In this instance, the fuel inlet could be disconnected and a downstream end of precombustion chamber 30 connected in place of the fuel inlet such that the precombustion chamber is now in communication with the main combustion chamber 14. A fuel source could then be connected to an upstream end of the precombustion chamber. An engine conversion of this type may be particularly suited to compression-ignition engines which do not rely on a sparkplug and therefore may typically have sufficient room at the cylinder head to accommodate a retrofitted precombustion chamber.

As discussed in the foregoing, embodiments of this disclosure in which the main combustion chamber is fuelled through the precombustion chamber may be particularly beneficial in two-stroke engines wherein the main combustion chamber is typically fuelled via the intake ports which leads to a high risk of fuel escaping the cylinder through the exhaust valves/ports during the scavenging process. By introducing into the main combustion chamber via the precombustion chamber, and by timing the injection after the closure of exhaust valves/ports, fuel slip might be advantageously reduced or eliminated.

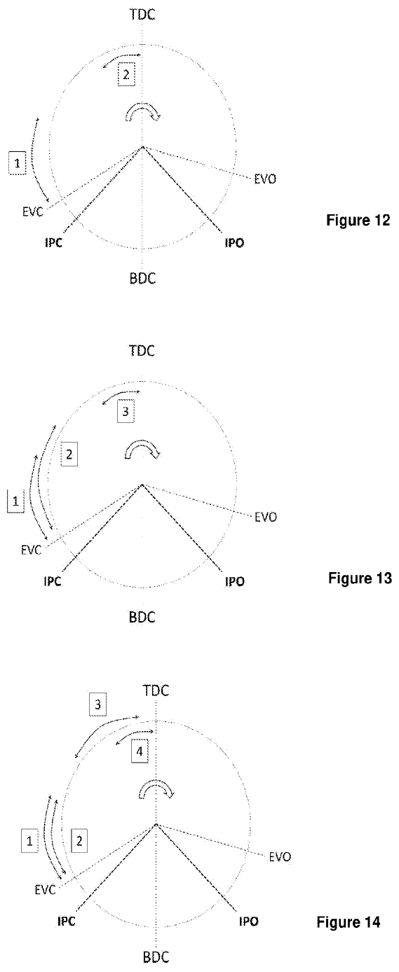

Turning to FIGS. 12-16, there are provided some exemplary engine injection and ignition timing diagrams for a variety of engine system embodiments according to this disclosure. In each of these diagrams, the following acronyms are used. EVO: exhaust valve opening IPO: inlet port opening IPC: inlet port closing EVC: exhaust valve closing TDC: top dead centre BDC: bottom dead centre.

FIG. 12 relates to an embodiment where a single fuel injector is used and, for example, could relate to the embodiments illustrated in FIGS. 8, 10 and 11. As can be seen from FIG. 12, fuel is injected into the precombustion chamber substantially after the exhaust valves are closed and is completed substantially prior to ignition. The period between end of injection and ignition allows for the fuel to be mixed well with air and fresh charge in the main chamber and as the piston moves towards TDC some of the air-fuel mixture is pushed back into the prechamber, overall creating an ignitable mixture in the prechamber.

The timing system illustrated in FIG. 12 may be utilised in the embodiment illustrated in FIG. 11 where primarily an ammonia fuel was used. For example, the ammonia fuel could be in either liquid or gaseous form and a high-energy spark ignition system with one to two spark plugs could be used to boost flammability. The timing system illustrated in FIG. 12 might also be utilised where partially cracked ammonia gas comprising hydrogen is introduced into both the precombustion chamber and the main combustion chamber via a single injector, such as in the embodiments illustrated in FIGS. 8 and 10.

FIGS. 13-16 are examples of potential injection and ignition timings for embodiments of this disclosure with two injectors at the precombustion chamber and as shown in FIG. 9. Each diagram indicates a labelled temporal sequence 1-4 which correspond to the actions defined below in respect of each Figure:

FIG. 13: 1. Primary fuel injection window, 2. Secondary fuel injection window, 3. Ignition window

FIG. 14: 1. Primary fuel injection window, 2. Secondary fuel first injection window, 3. Secondary fuel second injection window, 4. Ignition window

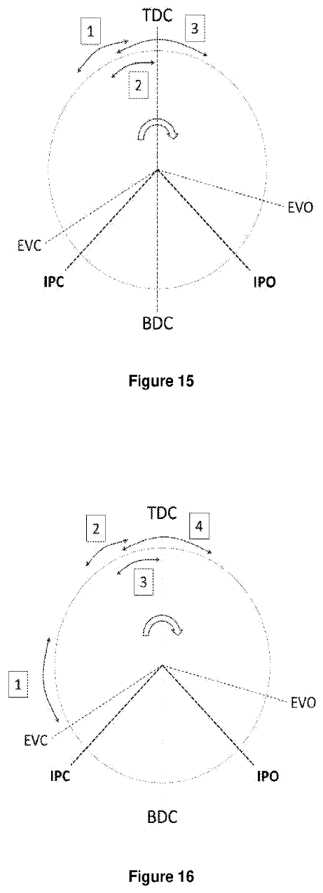

FIG. 15: 1. Secondary fuel injection window, 2. Ignition window, 3. Primary fuel injection window

FIG. 16: 1. Secondary fuel first injection window, 2. Secondary fuel second injection window, 3. Ignition window, 4. Primary fuel injection window

In the above examples, it will be appreciated that the ‘primary fuel’ relates to a main fuel which is introduced into the main combustion chamber and the ‘secondary fuel’ is the fuel introduced into the precombustion chamber for the purpose of being ignited in the precombustion chamber to promote or supplement combustion of the primary fuel in the main combustion chamber. In some embodiments, the primary fuel may be ammonia fuel and the secondary fuel may be a hydrogen-containing fuel such as a cracked fuel (or otherwise partially cracked fuel) provided from a cracking device. In some alternative examples, the secondary fuel may be hydrogen provided by a hydrogen tank.

It will be appreciated that the various injection strategies for both a precombustion fuel injector and a main fuel injector can be implemented depending on injection pressure. In some instances, a higher injection pressure has the potential to improve combustion by performing late injection/s during the compression stroke, as shown in FIG. 14, FIG. 15 and FIG. 16. For example, if a pressurised hydrogen supply was used as the precombustion fuel, split injections can be performed where a first injection is performed during the intake or early compression stroke when the piston is near BDC or after the exhaust valves are closed in case of two stroke engines and a second late injection in the compression stroke. This way the first injection may result in some hydrogen in the main chamber which will improve flammability when ammonia in the main chamber ignites, and the second late injection will result in higher turbulence and concentration of hydrogen in the prechamber which will significantly increase enthalpy of flame jets and in turn would result in faster and more complete combustion of ammonia in the main chamber.

In some embodiments, it will be advantageous to maintain choked flow for better injection mass control and repeatability. In most scenarios choked flow is anticipated to be achieved when the pressure upstream of the injector is at least twice the pressure in the precombustion chamber, during the entire period of injection. The main fuel (for example an ammonia fuel) can be injected during the intake or early compression stroke if low injection pressure is used. In some embodiments, Ammonia fuel may be pressurised into liquid form or used as a compressed gas or as supercritical fluid.

In yet another example, ammonia can also be combusted in mixing-controlled combustion mode as shown in FIGS. 15 and 16, wherein hydrogen-containing fuel is injected first at a relatively late portion of the compression stroke and is ignited and then immediately as combusting fluid streams enter the main combustion chamber, ammonia fuel is injected which enters the main combustion chamber behind the flame jets and is ignited. This timing mode may advantageously result in a substantially higher concentration of hydrogen being present in the precombustion chamber than hydrogen concentration in the main combustion chamber, at the time of ignition.

It must be noted that the injection windows shown in the examples of FIGS. 12 to 16 are not to be misunderstood as injection durations but as periods where substantial injection is performed. It must be noted that the injection windows shown in the examples of FIGS. 12 to 16 are not limited to two-stroke engine cycle and can be implemented in a four-stroke engine cycle.

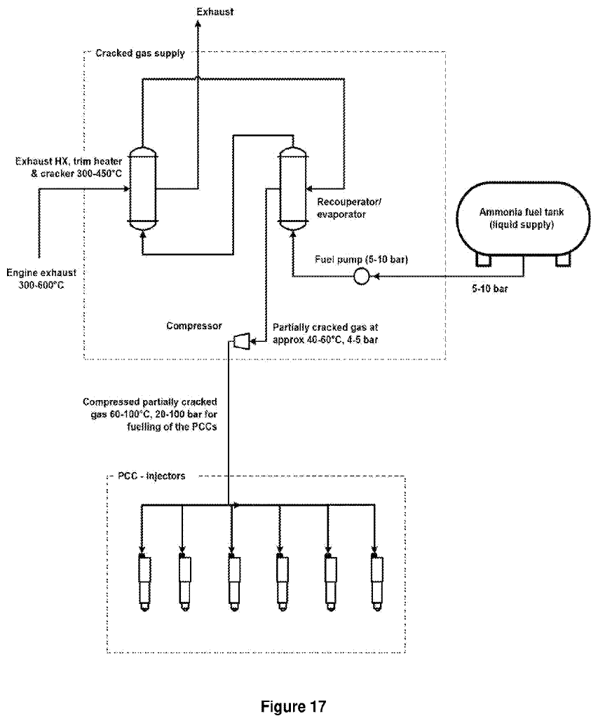

FIGS. 17 to 23 provide various fuel schematics in which cracked fuel is supplied to precombustion chamber fuel injectors (PCC-injectors) at various exemplary pressures and temperatures. FIGS. 17-21 also illustrate a suitable ammonia cracking process which may be performed by a cracking device as part of an engine according to this disclosure.

As shown in each of the examples in FIGS. 17-21, ammonia passes from an ammonia fuel tank through an evaporator portion of a recuperator/evaporator device in which the ammonia fuel receives heat. The ammonia fuel passes to an exhaust heat exchanger (HX), heater and cracker device which is provided with heat from the engine exhaust and which produces the cracked ammonia comprising a mixture of hydrogen, nitrogen and in some cases also uncracked ammonia. The mixture then passes through recuperator portion of the recuperator/evaporator device which it is cooled and passes heat to ammonia passing through the evaporator portion of the recuperator/evaporator device. The cooled mixture then passes through a compressor to increase cracked fuel pressure before flowing to the PCC-injectors. FIGS. 17-21 provide various examples of how this general process might be arranged to provide cracked fuel of differing temperatures and pressures at the PCC-injectors.

The use of a catalytic cracker may be particularly advantageous as compared to catalyst-less forms of ammonia cracked. While ammonia can be cracked without using a catalyst, it will be appreciated that catalytic cracking lowers the temperature needed for cracking and allows cracking at higher pressures. Theis may advantageously allow for greater use of waste engine heat from the exhaust, intercooler and coolant for vaporising a liquid ammonia supply and heating and supplying the heat energy required for decomposition thereby effectively increasing the overall efficiency of the engine. Cracking at higher pressure is advantageous in that it allows a higher feed pressure of liquid ammonia, thereby reducing the need for compression of cracked ammonia.

Referenced herein to ‘upward’ or ‘downward’ movement of the piston within the cylinder will be understood with reference to the illustrated embodiments in which the cylinder is shown in an upright orientation with the cylinder head positioned above the main combustion chamber. It will be appreciated that internal combustion cylinders need not necessarily have an upright orientation. References herein to ‘upward’ movement of the piston will therefore be understood as meaning movement toward the cylinder head (and in which the internal volume of the main combustion chamber is reduced) and referenced herein to ‘downward’ movement of the piston will be understood as meaning movement away from the cylinder head (and in which the internal volume of the main combustion chamber is increased).

References herein to a ‘precombustion chamber’ will be understood as meaning an enclosed volume in communication with a main combustion chamber via one or more orifices, or the like, and through which combusting gases from the precombustion chamber to enter to the main combustion chamber to facilitate combustion of fuel present in the main combustion chamber. The precombustion chamber need not be limited to any particular shape, volume or configuration and these parameters could vary depending on the particular application of the engine system. For example, in some cases, different pre combustion chambers may have different orifices, or otherwise may be formed differently with ignition devices, but nonetheless still provide an enclosed volume, in fluid communication with a main chamber, and configured to facilitate combustion fluids to pass (e.g., jet) to the main chamber to facilitate/support combustion in that main chamber. A skilled reader will readily be able to implement the various embodiments accordingly.

Finally, whilst the embodiments illustrated herein relate to internal combustion engines having a piston, it will be appreciated that an engine according to the present disclosure could be a piston-less engine such as a rotary engine which does not include a piston. In this regard, references herein to a ‘cylinder’ will be understood as encompassing both a conventional reciprocating internal combustion engine cylinder which houses a piston, and also encompassing a rotary engine cylinder housing which contains a generally rotor, rotating within the cylinder housing. An example of a well know rotary type engine is the Wankel engine.

Those skilled in the art will appreciate that the disclosure described herein is susceptible to variations and modifications other than those specifically described. It is understood that the disclosure includes all such variations and modifications which fall within the spirit and scope of the present disclosure.

Where any or all of the terms “comprise”, “comprises”, “comprised” or “comprising” are used in this specification (including the claims) they are to be interpreted as specifying the presence of the stated features, integers, steps or components, but not precluding the presence of one or more other features, integers, steps or components.

1.-84. (canceled)

85. An ammonia-fuelled internal combustion engine system comprising:
a cracking device connectable to an ammonia fuel supply and configured, during operation of the engine, to produce a cracked fuel comprising a mixture of nitrogen and hydrogen by cracking of an ammonia fuel provided by the ammonia fuel supply;
a main combustion chamber, an intake and an exhaust each in fluid communication with the main combustion chamber;
a precombustion chamber in fluid communication with the main combustion chamber via at least one orifice, the precombustion chamber further comprising a cracked fuel inlet to permit introduction of the cracked fuel, supplied from the cracking device, into the precombustion chamber;
an ignition device operatively positioned with the precombustion chamber and configured to ignite the cracked fuel in the precombustion chamber, wherein the precombustion chamber and/or the orifice are configured to produce a stream of combusting fluid from the precombustion chamber to the main combustion chamber via the orifice, when cracked fuel is ignited in the precombustion chamber, so as to permit ignition of fuel present in the main combustion chamber;
a sensor arrangement configured to measure properties of the cracked fuel;
an electronic control device in communication with the sensor arrangement and with the ignition device, the electronic control device configured to evaluate a characteristic of the hydrogen present in the cracked fuel using measurements received from the sensor arrangement and to control introduction of cracked fuel into the precombustion chamber according to those evaluated hydrogen characteristics.

86. An ammonia-fuelled internal combustion engine system according to claim 85, wherein the sensor arrangement and the electronic control device are configured to evaluate one or more of hydrogen concentration in the cracked fuel or pressure or temperature of hydrogen present in the cracked fuel.

87. An ammonia-fuelled internal combustion engine system according to claim 85, wherein the sensor arrangement comprises a cracking device temperature sensor configured to measure the temperature of the cracking device and wherein the electronic control device is configured to evaluate a characteristic of the hydrogen present in the cracked fuel using the cracking device temperature measurement received from the cracking device temperature sensor.

88. An ammonia-fuelled internal combustion engine system according to claim 85, wherein the electronic control device is configured to control the amount of hydrogen present in the precombustion chamber by controlling the amount of cracked fuel introduced into the precombustion chamber.

89. An ammonia-fuelled internal combustion engine system according to claim 85, wherein the electronic control device is configured to adjust the composition of the cracked fuel introduced into the precombustion chamber.

90. An ammonia-fuelled internal combustion engine system according to claim 85, wherein the electronic control device is configured to control operation of the cracking device to adjust concentration of hydrogen present in the cracked fuel.

91. An ammonia-fuelled internal combustion engine system according to claim 85, wherein the electronic control device controls operation of the cracking device according to a target hydrogen concentration of 5% to 35% by volume.

92. An ammonia-fuelled internal combustion engine system according to claim 85, wherein the fuel present in the main combustion chamber is cracked fuel produced by the cracking device and which is introduced into the main combustion chamber via the precombustion chamber and the orifice and wherein the electronic control device is configured to control introduction of cracked fuel into the main combustion chamber by, during operation, controlling the timing and/or duration of cracked fuel introduction into the precombustion chamber.

93. An ammonia-fuelled internal combustion engine system according to claim 85, comprising an ammonia fuel inlet configured to introduce ammonia fuel into the main combustion chamber and wherein the fuel present in the main combustion chamber comprises ammonia fuel introduced by the ammonia fuel inlet, the electronic control device being configured to control the introduction of ammonia fuel into the main combustion chamber and the introduction of cracked fuel into the precombustion chamber according to a target hydrogen concentration.

94. An ammonia-fuelled internal combustion engine system according to claim 93, wherein the electronic control device determines a volume of ammonia to be introduced into the main combustion chamber according to an evaluation by the electronic control device of the amount of hydrogen present in the cracked fuel.

95. An ammonia-fuelled internal combustion engine system according to claim 93, the electronic control device being configured to control the introduction of ammonia fuel into the main combustion chamber and the introduction of cracked fuel into the precombustion chamber according to a target hydrogen concentration, and optionally, wherein the target hydrogen concentration is 5% to 35%, by volume.

96. An ammonia-fuelled internal combustion engine system according to claim 93, wherein the cracked fuel inlet comprises a cracked fuel injector in communication with and controlled by the electronic control device, the ammonia fuel inlet comprises an ammonia fuel injector in communication with and controlled by the electronic control device and wherein, for each engine cycle, the electronic control device undertakes the following sequence of actions:
determine an engine operating request;
evaluate via the sensor arrangement the pressure and temperature of hydrogen in the cracked fuel produced by the cracking device;
set the timing and duration of the cracked fuel injector;
set the timing and duration of the ammonia fuel injector; and
set the ignition timing of the ignition device.

97. An ammonia-fuelled internal combustion engine system according to claim 85, wherein the cracking device is in thermal communication with waste heat produced by the engine.

98. A method of modifying an internal combustion engine system to reconfigure the engine as an ammonia-fuelled engine system, the method comprising:
fitting a precombustion chamber to a main combustion chamber of the internal combustion engine system with the precombustion chamber in fluid communication with the main combustion chamber via at least one orifice, the precombustion chamber comprising an ignition device configured to, during operation, permit ignition of fuel inside the precombustion chamber;
installing a cracking device connectable to an ammonia fuel supply and configured, during operation, to produce a cracked fuel comprising a mixture of nitrogen and hydrogen by cracking of an ammonia fuel provided by the ammonia fuel supply;
connecting the precombustion chamber to a supply of precombustion fuel comprising the cracked fuel obtained from the ammonia cracking device;
installing a sensor arrangement configured to measure properties of the cracked fuel;
installing or reconfiguring an electronic control device in electronic communication with the sensor arrangement and the ignition device, the electronic control device configured to evaluate a characteristic of the hydrogen present in the cracked fuel using measurements received from the sensor arrangement and to control introduction of cracked fuel into the precombustion chamber according to those evaluated hydrogen characteristics.

99. A method according to claim 98 comprising connecting the cracking device in thermal communication with a waste heat source of the internal combustion engine and controlling performance of the cracking device to vary hydrogen characteristics in the cracked fuel as a function of thermal energy available from the waste heat source.

100. A method of operating an ammonia-fuelled internal combustion engine which comprises a precombustion chamber in fluid communication with a main combustion chamber, the method comprising:
operating a cracking device fed with an ammonia fuel supply to produce a cracked fuel comprising a mixture of hydrogen and nitrogen;
introducing a fuel into the main combustion chamber;
introducing the cracked fuel from the cracking device into the precombustion chamber;
igniting the cracked fuel in the precombustion chamber to produce a stream of combusting gases entering the main combustion chamber from the precombustion chamber to ignite the fuel present in the main combustion chamber; and
controlling the introduction of cracked fuel into the precombustion chamber, using information received from a sensor arrangement associated with the cracked fuel.

101. A method according to claim 100, wherein the method comprises the step of injecting cracked fuel into the precombustion chamber during a compression stroke of the cylinder and wherein cracked fuel injection timing is selected to provide a choked flow condition across the cracked fuel injector.

102. A method according to claim 100, comprising the step of determining cracked fuel injection timing based on real-time measurement of pressure in the cracked fuel produced by the cracking device and on either pre-determined values or real-time measurement of pressure inside the precombustion chamber.

103. A method according to claim 100, comprising the step of commencing and completing a spray of ammonia fuel into the main combustion chamber prior to the stream of combusting gases entering the main combustion chamber from the precombustion chamber.

104. A method according to claim 100, comprising the step of commencing a spray of ammonia fuel into the main combustion chamber prior to the stream of combusting gases entering the main combustion chamber from the precombustion chamber.
